(19) United States
(12) Patent Application Publication
(10) Pub. No.: US 2025/0321953 A1
(43) Pub. Date: Oct. 16, 2025

(54) SCHEDULING METHOD FOR BLOCKCHAIN TRANSACTION, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Zhuguang SHAO, Shenzhen (CN)

(21) Appl. No.: 19/248,169

(22) Filed: Jun. 24, 2025

Related U.S. Application Data
(63) Continuation of application No. PCT/CN2023/131387, filed on Nov. 14, 2023.

(30) Foreign Application Priority Data
May 25, 2023 (CN) 202310604744.3

(51) Int. Cl. G06F 16/23

(52) U.S. Cl. CPC G06F 16/2379

(57) ABSTRACT

A scheduling method includes obtaining and executing blockchain transactions; obtaining a target transaction, that is completely executed, from the blockchain transactions, and determining a first conflict relationship between the target transaction and at least one first reference transaction, the first reference transaction being a currently, completely executed blockchain transaction other than the target transaction; obtaining a first weight of the target transaction and a second weight of the first reference transaction when the first conflict relationship indicates that a conflict exists between the target transaction and the first reference transaction, the first weight being determined based on a resource consumption parameter during execution of the target transaction, and the second weight being determined based on a resource consumption parameter during execution of the first reference transaction; and scheduling the target transaction according to a magnitude relationship between the first weight and the second weight.

### CROSS-REFERENCES TO RELATED APPLICATIONS

This application is a continuation application of PCT application No. PCT/CN2023/131387, filed on Nov. 14, 2023, which claims priority to Chinese Patent Application No. 2023106047443, filed on May 25, 2023, all of which is incorporated herein by reference in their entirety.

### FIELD OF THE TECHNOLOGY

The present disclosure generally relates to the field of blockchain technology and, in particular, to transaction scheduling technology in blockchain.

### BACKGROUND OF THE DISCLOSURE

Currently, during the execution of blockchain transactions, if there are conflicting transactions, the conflicting transactions must be executed in series. This requires scheduling the blockchain transactions, that is, retaining one of the blockchain transactions, while re-executing remaining blockchain transaction(s). Blockchain transactions are usually retained based on a preset order or the order in which the blockchain transactions are completely executed. However, this approach may lead to the re-execution of blockchain transactions that consume significant resources, resulting in wasted resources and reduced performance of the blockchain network.

### SUMMARY

One embodiment of the present disclosure provides a scheduling method for a blockchain transaction, performed by an electronic device. The method includes obtaining a plurality of blockchain transactions for execution, and executing the plurality of blockchain transactions; obtaining a target transaction, that is completely executed, from the blockchain transactions, and determining a first conflict relationship between the target transaction and a first reference transaction of at least one first reference transaction, the first reference transaction being a currently, completely executed blockchain transaction other than the target transaction; obtaining a first weight of the target transaction and a second weight of the first reference transaction when the first conflict relationship indicates that a conflict exists between the target transaction and the first reference transaction, the first weight being determined based on a resource consumption parameter during execution of the target transaction, and the second weight being determined based on a resource consumption parameter during execution of the first reference transaction; and scheduling the target transaction according to a magnitude relationship between the first weight and the second weight.

Another embodiment of the present disclosure provides an electronic device. The electronic device includes one or more processors and a memory containing a computer program that, when being executed, causes the one or more processors to perform: obtaining a plurality of blockchain transactions for execution, and executing the plurality of blockchain transactions; obtaining a target transaction, that is completely executed, from the blockchain transactions, and determining a first conflict relationship between the target transaction and a first reference transaction of at least one first reference transaction, the first reference transaction being a currently, completely executed blockchain transaction other than the target transaction; obtaining a first weight of the target transaction and a second weight of the first reference transaction when the first conflict relationship indicates that a conflict exists between the target transaction and the first reference transaction, the first weight being determined based on a resource consumption parameter during execution of the target transaction, and the second weight being determined based on a resource consumption parameter during execution of the first reference transaction; and scheduling the target transaction according to a magnitude relationship between the first weight and the second weight.

Another embodiment of the present disclosure provides a non-transitory computer-readable storage medium containing a computer program that, when being executed, causes at least one processor to perform: obtaining a plurality of blockchain transactions for execution, and executing the plurality of blockchain transactions; obtaining a target transaction, that is completely executed, from the blockchain transactions, and determining a first conflict relationship between the target transaction and a first reference transaction of at least one first reference transaction, the first reference transaction being a currently, completely executed blockchain transaction other than the target transaction; obtaining a first weight of the target transaction and a second weight of the first reference transaction when the first conflict relationship indicates that a conflict exists between the target transaction and the first reference transaction, the first weight being determined based on a resource consumption parameter during execution of the target transaction, and the second weight being determined based on a resource consumption parameter during execution of the first reference transaction; and scheduling the target transaction according to a magnitude relationship between the first weight and the second weight.

### BRIEF DESCRIPTION OF THE DRAWINGS

FIG. 1 is a schematic diagram of an exemplary implementation environment according to an embodiment of the present disclosure.

FIG. 2 is an exemplary schematic flowchart of a scheduling method for a blockchain transaction according to an embodiment of the present disclosure.

FIG. 3 is an exemplary schematic flowchart before deterministic scheduling optimization according to an embodiment of the present disclosure.

FIG. 4 is an exemplary schematic flowchart after deterministic scheduling optimization according to an embodiment of the present disclosure.

FIG. 5 is an exemplary schematic flowchart of a first scheduling phase according to an embodiment of the present disclosure.

FIG. 6 is an exemplary schematic flowchart of a second scheduling phase according to an embodiment of the present disclosure.

FIG. 7 is an exemplary schematic architecture diagram before non-deterministic scheduling optimization according to an embodiment of the present disclosure.

FIG. 8 is an exemplary schematic architecture diagram after non-deterministic scheduling optimization according to an embodiment of the present disclosure.

FIG. 9 is an exemplary schematic flowchart after non-deterministic scheduling optimization according to an embodiment of the present disclosure.

FIG. 10 is an exemplary schematic flowchart after non-deterministic scheduling optimization according to an embodiment of the present disclosure.

FIG. 11 is an exemplary schematic flowchart of inter-node block verification according to an embodiment of the present disclosure.

FIG. 12 is an exemplary schematic structural diagram of a scheduling apparatus for a blockchain transaction according to an embodiment of the present disclosure.

FIG. 13 is another exemplary schematic structural diagram of a scheduling apparatus for a blockchain transaction according to an embodiment of the present disclosure.

FIG. 14 is another exemplary schematic structural diagram of a scheduling apparatus for a blockchain transaction according to an embodiment of the present disclosure.

FIG. 15 is another exemplary schematic structural diagram of a scheduling apparatus for a blockchain transaction according to an embodiment of the present disclosure.

FIG. 16 is a partial structural block diagram of a terminal according to an embodiment of the present disclosure.

FIG. 17 is a partial structural block diagram of a server according to an embodiment of the present disclosure.

### DESCRIPTION OF EMBODIMENTS

To make the objectives, technical solutions, and advantages of the present disclosure clearer, the following further describes the present disclosure in detail with reference to the accompanying drawings and the embodiments. The specific embodiments described herein are merely configured for explaining the present disclosure but are not intended to limit the present disclosure.

Embodiments of the present disclosure disclose a scheduling method and apparatus for a blockchain transaction, an electronic device, and a storage medium. In the scheduling method for a blockchain transaction, a plurality of blockchain transactions are executed, a completely executed blockchain transaction is used as a target transaction, and when the target transaction and a first reference transaction that conflict with each other are scheduled, a first weight of the target transaction and a second weight of the first reference transaction are determined. The first weight and the second weight are both determined based on a resource consumption parameter. Therefore, scheduling the target transaction according to a magnitude relationship between the first weight and the second weight is equivalent to scheduling the target transaction according to the resource consumption parameter. Therefore, when the target transaction is scheduled, a blockchain transaction consuming a relatively large quantity of resources can be retained and a blockchain transaction consuming a relatively small quantity of resources can be re-executed, to avoid resource waste and improve performance of a blockchain network. This method can be widely applied to technical fields such as cloud computing and blockchains.

As disclosed, when related processing needs to be performed according to data related to a target object characteristic, such as attribute information or an attribute information set of a target object, permission or consent of the target object is first obtained, and collection, use, processing, and the like of the data comply with related laws and regulations and standards. The target object may be a user. In addition, when target object registration information needs to be obtained in embodiments of the present disclosure, individual permission or individual consent of the target object is obtained through a pop-up window or jumping to a confirmation page. After the individual permission or the individual consent of the target object is explicitly obtained, necessary target object-related data for enabling embodiments of the present disclosure to operate normally is obtained.

For ease of understanding the technical solutions provided in embodiments of the present disclosure, some key terms used in embodiments of the present disclosure are first explained herein.

A blockchain is a new application mode of computer technologies such as distributed data storage, point-to-point transmission, a consensus mechanism, and an encryption algorithm. The blockchain is essentially a decentralized database and is a string of related data blocks generated by using a cryptographic method. Each data block includes information of a batch of network transactions, the information being configured for verifying the validity of information of the data block (anti-counterfeiting) and generating a next data block.

The blockchain may include a blockchain underlying platform, a platform product service layer, and an application service layer. The blockchain underlying platform may include processing modules such as a user management module, a basic service, a smart contract module, and an operation detection module. The user management module is responsible for identity information management of all blockchain participants, including maintenance of public/private key generation (ledger management), key management, maintenance of a correspondence between a real user identity and a blockchain address (authority management), and the like. In addition, when authorized, the user management module monitors and audits transactions of some real identities, and provides risk control rule configuration (risk control audit). The basic service module is deployed on all blockchain node devices to verify effectiveness of a service request and record the effective request in a storage after a consensus is reached on the service request. For a new service request, the basic service module first performs adaptation analysis and authentication on an interface (interface adaptation), and then encrypts service information through a consensus algorithm (consensus management), transmits the encrypted service information to a shared ledger (network communication) in a complete and consistent manner after encryption, and records and stores the encrypted service information. The smart contract module is responsible for registration, issuance, triggering, and execution of a contract. A developer may define a contract logic through a specific programming language, publish the contract logic on the blockchain (contract registration), call a key or another event to trigger execution based on a logic of contract terms, complete the contract logic, and provide functions of contract upgrading and canceling. The operation detection module is mainly responsible for deployment, configuration modification, contract setting, and cloud adaptation during product release, and visualized outputs of a real-time status, for example, alarm, network condition detection, and node device health status detection. The platform product service layer provides basic capabilities and an implementation framework of a typical application. Based on these basic capabilities, developers may superpose characteristics of services and complete blockchain implementation of service logic. The application service layer provides application services based on blockchain solutions for service participants to use.

Cloud computing refers to a mode of delivery and use of an IT infrastructure, and a required resource is obtained through a network in an on-demand and easy-to-scale manner. Generalized cloud computing refers to a mode of service delivery and use, and a required service is obtained through a network in an on-demand and easy-to-scale manner. Such services may be related to IT, software, and the Internet, or may be other services. Cloud computing is a product of development and convergence of conventional computers and network technologies such as grid computing, distributed computing, parallel computing, utility computing, network storage, virtualization, load balancing, and the like.

Currently, in an execution process of a blockchain transaction, if there are blockchain transactions that conflict with each other, the blockchain transactions that conflict with each other need to be executed in series. In this case, the blockchain transactions need to be scheduled, that is, one of the blockchain transactions is retained, and a remaining blockchain transaction is re-executed. In a related technology, blockchain transactions are usually retained based on a preset transaction sequence or a sequence of time when the blockchain transactions are completely executed. This manner may cause a blockchain transaction that consumes a large quantity of resources to be re-executed, thereby causing resource waste and reducing performance of a blockchain network.

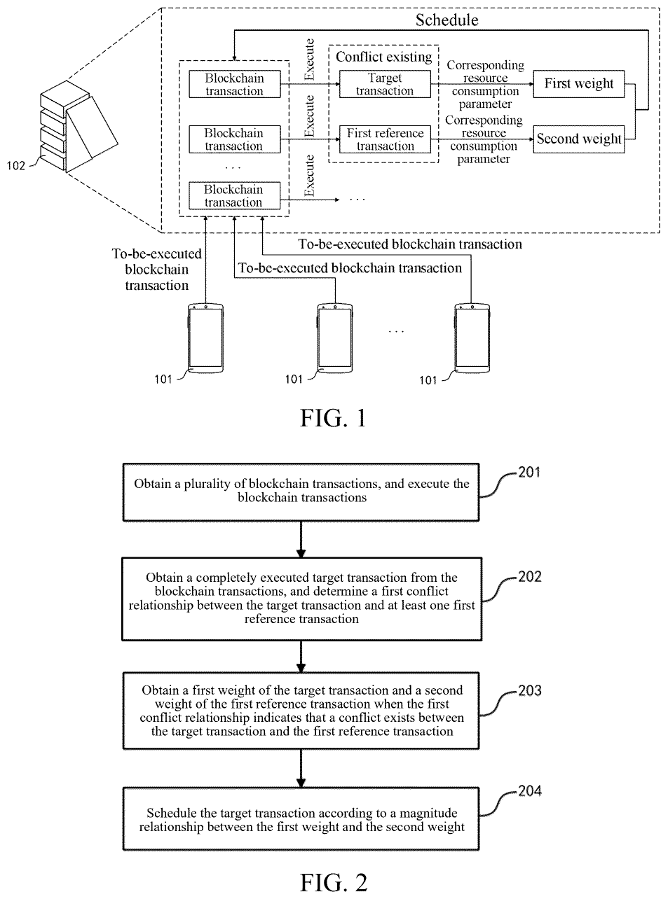

FIG. 1 is a schematic diagram of an exemplary implementation environment according to an embodiment of the present disclosure. The implementation environment includes a terminal 101 and a server 102. The terminal 101 and the server 102 are connected by using network communication, and there may be one or more terminals 101.

For example, any terminal 101 may transmit a to-be-executed blockchain transaction to the server 102, any two terminals 101 may transmit different blockchain transactions, the same terminal 101 may also transmit different blockchain transactions, and the server 102 may obtain a plurality of to-be-executed blockchain transactions, to execute each blockchain transaction. A completely executed target transaction is obtained from the blockchain transactions, and a first conflict relationship between the target transaction and at least one first reference transaction is determined, the first reference transaction being a currently completely executed blockchain transaction other than the target transaction. A first weight of the target transaction and a second weight of the first reference transaction are obtained when the first conflict relationship indicates that a conflict exists between the target transaction and the first reference transaction, the first weight being determined based on a resource consumption parameter during execution of the target transaction, and the second weight being determined based on a resource consumption parameter during execution of the first reference transaction. The target transaction is scheduled according to a magnitude relationship between the first weight and the second weight, for example, according to a comparison between the first weight and the second weight.

The server 102 executes a plurality of blockchain transactions, uses a completely executed blockchain transaction as a target transaction, and when the target transaction and a first reference transaction that conflict with each other are scheduled, obtains a first weight of the target transaction and a second weight of the first reference transaction. The first weight and the second weight are both determined based on resource consumption parameters when corresponding transactions are executed. Therefore, scheduling the target transaction according to a magnitude relationship between the first weight and the second weight is equivalent to scheduling the target transaction according to the resource consumption parameter. Therefore, when the target transaction is scheduled, a blockchain transaction consuming a relatively large quantity of resources can be retained and a blockchain transaction consuming a relatively small quantity of resources can be re-executed, to avoid resource waste and improve performance of a blockchain network.

The server 102 may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In addition, the server 102 may be a node server in a blockchain network.

The terminal 101 may be a smartphone, a tablet computer, a laptop, a desktop computer, a smart speaker, a smartwatch, an in-vehicle terminal, or the like, but is not limited thereto. The terminal 101 and the server 102 may be directly or indirectly connected in a wired or wireless communication mode. This is not limited in embodiments of the present disclosure.

The method provided in this embodiment of the present disclosure may be applied to various technical fields, including but not limited to the technical fields such as cloud computing and blockchain.

FIG. 2 is an exemplary schematic flowchart of a scheduling method for a blockchain transaction according to an embodiment of the present disclosure. The scheduling method for a blockchain transaction may be performed by an electronic device, specifically, may be performed by a server, or may be performed by a terminal, or may be performed by a server in cooperation with a terminal. The scheduling method for a blockchain transaction includes, but is not limited to, the following operation 201 to operation 204.

Operation 201: Obtain a plurality of to-be-executed blockchain transactions, and execute the blockchain transactions.

The blockchain transaction refers to a transaction generated in a blockchain network. A blockchain node in the blockchain network may execute the blockchain transaction. The blockchain node stores a ledger. The ledger includes a blockchain and a world state database. The world state database is a database that stores current states of all state data. The world state refers to the current states of all the state data. The blockchain is configured to record a historical transaction that is involved in a process of changing all the state data from an initial state to the current state. The state data may be stored in a form of a key-value pair, and the current state refers to a key of the state data, a value corresponding to the key, and a current version number. Execution of the blockchain transaction by the blockchain node refers to reading or writing the state data. If the blockchain transaction is configured for reading the state data, the blockchain transaction includes the key of the state data. If the blockchain transaction is configured for writing the state data, the blockchain transaction includes the key of the state data and the value corresponding to the key.

For example, a first blockchain transaction is configured for reading first state data, and writing second state data. The first blockchain transaction includes a key key1 of the first state data, a key key2 of the second state data, and a value value2′ of the key key2. When the first blockchain transaction is executed, the value value1 corresponding to the key key1 is read from the world state database. In this case, a current version number of the key key1 in the world state database does not change. Then, the value value2′ corresponding to the key key2 is written into the world state database. A version number corresponding to the key key2 in the world state database changes. For example, before the first blockchain transaction is executed, the world state database stores the key key2, the value corresponding to the key key2 is value2, and the current version number corresponding to the key key2 is 1. After the first blockchain transaction is executed, the value corresponding to the key key2 is updated to value 2′, the current version number corresponding to the key key2 is added by one, and the current version number corresponding to the key key2 is updated to 2.

Based on this, in this embodiment of the present disclosure, after the blockchain node obtains a plurality of to-be-executed blockchain transactions, the blockchain node may concurrently execute each blockchain transaction by using a plurality of threads. The thread may be replaced with an execution body such as a process or a coroutine. Each thread executes one blockchain transaction, and needs to correspond to the same initial world state for each blockchain transaction. This is equivalent to that an execution environment of each thread is the same. Specifically, a current world state is obtained from the world state database, the current world state is used as the initial world state, and then each thread respectively executes a corresponding blockchain transaction based on the same initial world state.

For example, a batch of to-be-executed blockchain transactions are obtained, and a quantity of the to-be-executed blockchain transactions is 20. Then, based on the same initial world state, after the 20 blockchain transactions are concurrently executed by using a plurality of threads, and the 20 blockchain transactions are all completely executed, an intermediate world state corresponding to each blockchain transaction can be obtained. Usually, because there is a difference between different blockchain transactions, the intermediate world state corresponding to each blockchain transaction is different, and therefore, 20 different intermediate world states can be obtained.

Operation 202: Obtain a completely executed target transaction from the blockchain transactions, and determine a first conflict relationship between the target transaction and at least one first reference transaction.

The first reference transaction is a currently completely executed blockchain transaction other than the target transaction.

Execution time of different blockchain transactions may be different. When the blockchain transaction is completely executed, the completely executed blockchain transaction may be used as the target transaction. If the target transaction is completely executed, no other blockchain transaction is completely executed, indicating that no other blockchain transaction conflicts with the target transaction at a moment at which the target transaction is completely executed. On the contrary, when the target transaction is completely executed, another blockchain transaction has been completely executed. At the moment at which the target transaction is completely executed, another blockchain transaction and the target transaction may have a conflict. Therefore, the currently completely executed blockchain transaction other than the target transaction is used as the first reference transaction, conflict detection is performed on the target transaction and the first reference transaction, and the first conflict relationship between the target transaction and the first reference transaction is determined. The first conflict relationship is configured for indicating whether a conflict exists between the target transaction and the first reference transaction.

For example, based on the foregoing content about concurrently executing the 20 blockchain transactions by using a plurality of threads, 20 corresponding intermediate world states can be obtained after the 20 blockchain transactions are completely executed. Because in a process of executing each blockchain transaction, a corresponding read set and write set are created for each blockchain transaction. The read set is configured for indicating state data read when the blockchain transaction is executed. Therefore, the read set includes a key of the read state data and a committed version number corresponding to the key, and the read set may further include a value corresponding to the key of the read state data. The write set is configured for indicating state data inserted, deleted, or updated during execution of the blockchain transaction. Therefore, the write set includes a key of the written state data and a value corresponding to the key. The read set and the write set of the blockchain transaction may be collectively referred to as a read-write set of the blockchain transaction.

In a plurality of blockchain transactions executed in series, when a current state of corresponding state data is updated after a blockchain transaction that is earlier in execution is completely executed, a current version number corresponding to a key changes. When the blockchain transaction that is earlier in execution is executed, and state data needs to be read, the current version number corresponding to the key of the state data is read. If the version number corresponding to the key is updated when the blockchain transaction that is earlier in execution is executed, the current version number corresponding to the key is an updated version number, and the updated version number is used as a committed version number corresponding to the key, and is recorded in the read set.

Therefore, executing 20 blockchain transactions can obtain 20 read-write sets. In an ideal state, any two read-write sets do not intersect with each other, and that two read-write sets do not intersect with each other means that the two read-write sets do not include the same key. In this case, the foregoing 20 blockchain transactions may be executed in parallel, 20 intermediate world states obtained through execution may be directly combined, to obtain a final world state, and then the final world state is used as an execution result of executing the batch of blockchain transactions. Usually, there is at least one pair of intersecting read-write sets. That two read-write sets intersect with each other means that the two read-write sets include at least one same key. When a read-write set of one blockchain transaction intersect intersects with a read-write set of another blockchain transaction intersect, it is equivalent to that the two blockchain transactions conflict with each other, and the conflicting blockchain transactions need to be executed in series.

Operation 203: Obtain a first weight of the target transaction and a second weight of the first reference transaction when the first conflict relationship indicates that a conflict exists between the target transaction and the first reference transaction.

The first weight is determined based on a resource consumption parameter during execution of the target transaction, and the second weight is determined based on a resource consumption parameter during execution of the first reference transaction.

The resource consumption parameter is configured for indicating a resource needing to be consumed for executing a blockchain transaction. The resource may be a time resource, a memory resource, or the like. For example, when the resource is a time resource, the resource consumption parameter may be execution time of the blockchain transaction, and when the resource is a memory resource, the resource consumption parameter may be at least one of a quantity of read set keys, a size of a read set memory, a quantity of write set keys, and a size of a write set memory.

When the first conflict relationship indicates that a conflict exists between the target transaction and the first reference transaction, the target transaction and the first reference transaction need to be executed in series. The first weight of the target transaction is determined based on the resource consumption parameter during execution of the target transaction, and the second weight of the first reference transaction is determined based on the resource consumption parameter during execution of the first reference transaction. Then, the target transaction and the first reference transaction are scheduled according to a weight magnitude between the first weight of the target transaction and the second weight of the first reference transaction.

Operation 204: Schedule the target transaction according to a magnitude relationship between the first weight and the second weight.

Specifically, when the weight is positively correlated to the resource consumption parameter, that is, when a larger quantity of consumed resources corresponds to a larger weight, if the first weight is greater than the second weight, more resources are consumed when the target transaction is executed relative to resources consumed when the first reference transaction is executed, the target transaction may be retained, and the first reference transaction is re-executed. If the first weight is less than the second weight, fewer resources are consumed when the target transaction is executed relative to resources consumed when the first reference transaction is executed, the first reference transaction may be retained, and the target transaction is re-executed.

The first weight and the second weight are both determined based on a resource consumption parameter. Therefore, scheduling the target transaction according to a magnitude relationship between the first weight and the second weight is equivalent to scheduling the target transaction according to the resource consumption parameter. Therefore, when the target transaction is scheduled, a blockchain transaction consuming a relatively large quantity of resources can be retained and a blockchain transaction consuming a relatively small quantity of resources can be re-executed, to avoid resource waste and improve performance of a blockchain network.

In one embodiment, the scheduling the target transaction according to a magnitude relationship between the first weight and the second weight may be specifically:
scheduling the target transaction according to a magnitude relationship between the first weight and each second weight; or
calculating a sum of second weights as a first weight sum, and scheduling the target transaction according to a magnitude relationship between the first weight and the first weight sum.

The magnitude relationship between the first weight and each second weight means that the first weight is greater than the second weight, or the first weight is less than the second weight, or the first weight equals to the second weight. The magnitude relationship between the first weight and the first weight sum means that the first weight is greater than the first weight sum, or the first weight is less than the first weight sum, or the first weight equals to the first weight sum.

By comparing the first weight with each second weight, whether resource consumption when the target transaction is executed is greater than resource consumption when each first reference transaction is executed can be effectively determined, so as to retain a blockchain transaction with a relatively large quantity of resources and re-execute a blockchain transaction with a relatively small quantity of resources, thereby avoiding resource waste and improving performance of the blockchain network.

In one embodiment, the target transaction is obtained when all the obtained blockchain transactions are completely executed, the first reference transaction is not added to the transaction snapshot, and the scheduling the target transaction according to a magnitude relationship between the first weight and each second weight may be specifically:
adding the target transaction to the transaction snapshot when the first weight is greater than each second weight; or
re-executing the target transaction when the first weight is less than any second weight; or
adding the target transaction to the transaction snapshot or re-executing the target transaction when the first weight equals to a maximum value in the second weights.

The transaction snapshot refers to a completion queue of the blockchain transaction. After the blockchain transaction is completely executed, adding the completely executed blockchain to the transaction snapshot is equivalent to adding the completely executed blockchain to a tail of the completion queue. When a plurality of blockchain transactions are concurrently executed by using a plurality of threads, there may be a plurality of completion queues, and a quantity of completion queues depends on a quantity of blockchain transactions that can be concurrently executed. When a plurality of blockchain transactions that have a conflicting relationship with each other correspond to the same completion queue, a blockchain transaction that is first added to the transaction snapshot is at a front location in the completion queue, and a blockchain transaction that is later added to the transaction snapshot is at a rear location in the completion queue, and subsequently, the blockchain transactions that have a conflicting relationship with each other may be sequentially executed according to sorting in the completion queue.

The blockchain transaction may be scheduled in a deterministic scheduling manner, an execution result of each blockchain transaction is determined, the deterministic scheduling is to perform conflict detection on the blockchain transaction in a round-robin manner, and a time point of conflict detection in the deterministic scheduling is configured as follows: When all blockchain transactions are completely executed, conflict detection is separately performed on each completely executed blockchain transaction, and a conflict relationship between completely executed blockchain transactions is determined. For example, in the first round, only when all the blockchain transactions are completely executed, conflict detection is performed on the blockchain transactions, and a conflict relationship between the blockchain transactions is determined. A result of conflict detection may be that no conflict exists between the plurality of blockchain transactions, or a result of conflict detection may be that a conflict exists between the plurality of blockchain transactions, and the result of conflict detection is that a conflict or no conflict exists between the plurality of blockchain transactions. When the result of conflict detection indicates that no conflict exists between the plurality of blockchain transactions, the plurality of blockchain transactions may be executed in parallel. When the result of conflict detection indicates that a conflict exists between the plurality of blockchain transactions, the plurality of blockchain transactions need to be executed in series.

For a plurality of blockchain transactions that conflict with each other, in a current round, only one of the blockchain transactions is retained, the blockchain transaction is added to the transaction snapshot, and a remaining blockchain transaction is re-executed in a next round. Because the deterministic scheduling processes a conflict between the blockchain transactions in a round manner, in the next round, when all blockchain transactions that need to be re-executed are completely re-executed, conflict detection is performed on the blockchain transactions. Therefore, in the deterministic scheduling, the target transaction is obtained when all the obtained blockchain transactions are completely executed, the first reference transaction to be conflict detected is not added to the transaction snapshot, and conflict detection does not need to be performed on the first reference transaction that has been added to the transaction snapshot.

Currently, when a plurality of blockchain transactions that conflict with each other is scheduled in the deterministic scheduling manner, a blockchain transaction that is first completely executed is added to the transaction snapshot according to a sequence of time when the blockchain transactions are completely executed, and a remaining blockchain transaction is re-executed. This may cause a blockchain transaction that consumes a large quantity of resources to be re-executed, thereby causing resource waste and reducing performance of the blockchain network.

Based on this, the scheduling method provided in this embodiment of the present disclosure can optimize deterministic scheduling. When the target transaction and the first reference transaction that conflict with each other are scheduled, the first weight of the target transaction and the second weight of the first reference transaction are first obtained. The first weight and the second weight are respectively determined based on the resource consumption parameters during execution of the target transaction and execution of the first reference transaction. Therefore, scheduling the target transaction according to the magnitude relationship between the first weight and the second weight is equivalent to scheduling the target transaction according to the corresponding resource consumption parameter. The resource consumption parameter is configured for indicating a resource required to be consumed for executing a blockchain transaction. The first weight is configured for indicating a resource required for executing the target transaction. The second weight is configured for indicating a resource required for executing the first reference transaction. When the resource required for executing the target transaction is relatively small, the first weight of the target transaction is relatively small. Otherwise, when the resource required for executing the target transaction is relatively large, the first weight of the target transaction is relatively large. Similarly, when the resource required for executing the first reference transaction is relatively small, the second weight of the first reference transaction is relatively small. Otherwise, when the resource required for executing the first reference transaction is relatively large, the second weight of the first reference transaction is relatively large.

Specifically, for the three comparison cases of the first weight and the second weight, when the first weight is the largest, the target transaction is retained and added to the transaction snapshot; when the first weight is less than any second weight, the target transaction is re-executed; and when the first weight is the same as the largest value of the second weights, the target transaction may be added to the transaction snapshot, or the target transaction may be re-executed, so that when the target transaction is scheduled, a blockchain transaction with relatively high resource consumption is retained, and a blockchain transaction with relatively low resource consumption is re-executed, thereby avoiding resource waste and improving performance of the blockchain network.

For example, for three blockchain transactions that conflict with each other: A, B, and C, before the blockchain transactions are executed, it may be determined that sequence numbers of the three blockchain transactions are: A<B<C, the three blockchain transactions are executed in parallel, and an execution result in the first round is: A, B, and C. It is assumed that sizes of resources that need to be consumed for executing the three blockchain transactions are sorted as follows: A<B<C. In the first round, when the three blockchain transactions are all completely executed, conflict detection is performed on the blockchain transactions. Because the blockchain transaction A, the blockchain transaction B, and the blockchain transaction C conflict with each other, the blockchain transaction A, the blockchain transaction B, and the blockchain transaction C need to be scheduled, and one of the blockchain transactions A, B, and C is used as the target transaction, and the remaining blockchain transactions are used as the first reference transactions. When the blockchain transaction A is the target transaction, and the blockchain transaction B and the blockchain transaction C are the first reference transactions, a first weight of the blockchain transaction A is less a second weight of the blockchain transaction B, and the first weight of the blockchain transaction A is less than a second weight of the blockchain transaction C. Therefore, in a next round, the blockchain transaction A is re-executed. Similarly, when the blockchain transaction B is the target transaction, and the blockchain transaction A and the blockchain transaction C are the first reference transactions, the first weight of the blockchain transaction B is less than the second weight of the blockchain transaction C, and it can be determined that the blockchain transaction B needs to be re-executed in a next round. In the next round, the blockchain transaction A and the blockchain transaction B may be executed in parallel. When the blockchain transaction C is the target transaction, and the blockchain transaction A and the blockchain transaction B are the first reference transactions, the first weight of the blockchain transaction C is greater than the second weight of the blockchain transaction A, and the first weight of the blockchain transaction C is greater than the second weight of the blockchain transaction B. Therefore, the blockchain transaction C is added to the transaction snapshot. Therefore, in the first round of conflict processing, the blockchain transaction C that consumes more resources is retained, the blockchain transaction C is added to the transaction snapshot, and the blockchain transaction A and the blockchain transaction B that consume fewer resources are re-executed. Similarly, in the second round of conflict processing, the blockchain transaction B that consumes more resources is retained, the blockchain transaction B is added to the transaction snapshot, and the blockchain transaction A that consumes fewer resources is re-executed, so as to avoid resource waste and improve performance of the blockchain network.

In one embodiment, the adding the target transaction to the transaction snapshot or re-executing the target transaction may be specifically: forming a first transaction set by using the target transaction and a first reference transaction corresponding to a second weight equal to the first weight; and adding any blockchain transaction in the first transaction set to the transaction snapshot, and re-executing a remaining blockchain transaction in the first transaction set.

Based on this, when a case that the first weight is the same as the maximum value of the second weights is processed, that is, a case that the first weight is the same as some of the second weights and the first weight is greater than a remaining second weight, the target transaction and the first reference transaction whose first weight equals to that of the target transaction are combined into a first transaction set, then a blockchain transaction that needs to be added to the transaction snapshot is selected from the first transaction set, and a blockchain transaction that needs to be re-executed is selected, so that conflicting blockchain transactions can be executed in series.

The blockchain transaction to be added to the transaction snapshot may be selected through random selection. Specifically, a blockchain transaction is randomly selected from the first transaction set to be added to the transaction snapshot, and a remaining blockchain transaction in the first transaction set is re-executed. When all the blockchain transactions are added to the transaction snapshot, in results of each random selection, no matter which blockchain transaction is selected to be added to the transaction snapshot, it can be ensured that conflicting blockchain transactions can be executed in series.

Based on this, when selection is performed through random selection, an execution sequence of a plurality of blockchain transactions executed in series is not fixed. However, as long as execution results obtained after all the blockchain transactions are completely executed are the same, consensus can be subsequently completed. An execution process of the blockchain transactions is as follows: A transaction execution function in a smart contract is first invoked, and then historical transaction data is processed according to the transaction execution function and a blockchain transaction. There may be a plurality of smart contracts, and a plurality of transaction execution functions may be deployed in one smart contract. Therefore, a corresponding transaction execution function in a corresponding smart contract needs to be invoked. The historical transaction data is state data in an initial world state before the blockchain transaction is executed, and an execution result of the blockchain transaction is a final world state after the blockchain transaction is executed. Therefore, when blockchain transactions that do not conflict with each other are executed in parallel and blockchain transactions that conflict with each other are executed in series, the execution sequence of the plurality of blockchain transactions executed in series is changed, so that the final world states obtained after all the blockchain transactions are executed are the same.

The state data may be stored in a form of a key-value pair. Different blockchain transactions may be configured for processing state data corresponding to different keys, or may be configured for processing state data corresponding to the same key. When different blockchain transactions are configured for processing state data corresponding to the same key, and the blockchain transactions are executed in parallel, the blockchain transactions conflict with each other.

For example, a batch of to-be-executed blockchain transactions totally have three transactions. Details are as follows: A first blockchain transaction is that a first object transfers 100 yuan to a second object by using an account of the first object, a second blockchain transaction is that the first object transfers 200 yuan to a third object by using the account of the first object, and a third blockchain transaction is that a fourth object transfers 200 yuan to a fifth object by using an account of the fourth object. Before each blockchain transaction is executed, corresponding state data in an initial world state is specifically as follows: First historical transaction data is that 500 yuan exists in the account of the first object, and second historical transaction data is that 300 yuan exists in the account of the fourth object.

Through conflict detection, it can be determined that the first blockchain transaction and the second blockchain transaction conflict with each other. The first blockchain transaction and the second blockchain transaction need to be executed in series, the third blockchain transaction does not conflict with a remaining blockchain transaction, and the third blockchain transaction and the remaining blockchain transaction may be concurrently executed.

Assuming that resources required to be consumed for executing the first blockchain transaction and the second blockchain transaction are the same, which is equivalent to that weights of the first blockchain transaction and the second blockchain transaction are the same, selection may be performed in a manner of random selection.

In the first case: First, a first transaction execution function is invoked to execute the first blockchain transaction, and the first historical transaction data is processed, so that an obtained first execution result is that 400 yuan exists in the account of the first object; then, the first execution result is used as historical transaction data; and then, a second transaction execution function is invoked to execute the second blockchain transaction, and the first execution result is processed, so that an obtained second execution result is that 200 yuan exists in the account of the first object. In the execution process of the first blockchain transaction and the second blockchain transaction, the third blockchain transaction may be executed in parallel, a third transaction execution function is invoked to execute the third blockchain transaction, and third historical transaction data is processed. An obtained third execution result is that 100 yuan exists in the account of the fourth object. Therefore, a final world state obtained after all the blockchain transactions are executed is: There are 200 yuan in the account of the first object, and 100 yuan in the account of the fourth object.

In the second case: First, a second transaction execution function is invoked to execute the second blockchain transaction, and the first historical transaction data is processed, so that an obtained first execution result is that 300 yuan exists in the account of the first object; then, the first execution result is used as historical transaction data; and then, a first transaction execution function is invoked to execute the first blockchain transaction, and the first execution result is processed, so that an obtained second execution result is that 200 yuan exists in the account of the first object. In the execution process of the first blockchain transaction and the second blockchain transaction, the third blockchain transaction may be executed in parallel, a third transaction execution function is invoked to execute the third blockchain transaction, and third historical transaction data is processed. An obtained third execution result is that 100 yuan exists in the account of the fourth object. Therefore, a final world state obtained after all the blockchain transactions are executed is: There are 200 yuan in the account of the first object, and 100 yuan in the account of the fourth object.

It can be learned that, compared with the first case, in the second case, the final world state obtained after all the blockchain transactions are executed is not changed. Therefore, when blockchain transactions that do not conflict with each other are executed in parallel and blockchain transactions that conflict with each other are executed in series, the execution sequence of the plurality of blockchain transactions executed in series is changed, so that the final world states obtained after all the blockchain transactions are executed are the same.

Selection may alternatively be performed in a fixed selection manner. Specifically, a blockchain transaction that is in a fixed location in the first transaction set is added to the transaction snapshot, and a remaining blockchain transaction in the first transaction set is re-executed. Assuming that the blockchain transactions are sequentially arranged in the first transaction set, and the fixed location may be the first or the last location, the blockchain transaction in the first transaction set that is at the first or the last location is added to the transaction snapshot. The fixed location may alternatively be a middle location. When a quantity of blockchain transactions in the first transaction set is an even number, a value that is a half of the quantity is used as a value at the middle location. For example, the quantity of transactions is 4, and a value at the middle location is 2. Therefore, a blockchain transaction that is located at the second location in the first transaction set is added to the transaction snapshot. Similarly, the manner of fixed selection also does not affect the execution result of the blockchain transaction.

In one embodiment, the scheduling method for a blockchain transaction further includes:
using, when blockchain transactions not added to the transaction snapshot are completely re-executed, a blockchain transaction that is completely re-executed and that is not added to the transaction snapshot as the target transaction; and
scheduling the target transaction again, until all the blockchain transactions are added to the transaction snapshot.

Transaction scheduling may be performed on the target transaction in a deterministic scheduling manner. In deterministic scheduling, conflict detection is performed on the blockchain transactions in a round manner. For example, in the first round, conflict detection is performed on the blockchain transactions only when all the blockchain transactions are completely executed, and a conflict relationship between the blockchain transactions is determined. A result of conflict detection may be that no conflict exists between a plurality of blockchain transactions, or a result of conflict detection may be that a conflict exists between a plurality of blockchain transactions. When the result of conflict detection indicates that no conflict exists between the plurality of blockchain transactions, the plurality of blockchain transactions can be executed in parallel. Therefore, when the target transaction does not conflict with each first reference transaction, the target transaction may be added to the transaction snapshot, and the target transaction does not need to be re-executed. However, when the result of conflict detection indicates that a conflict exists between a plurality of blockchain transactions, the plurality of blockchain transactions need to be executed in series.

When the target transaction and the first reference transaction conflict with each other, the target transaction cannot be executed in parallel with the conflicting first reference transaction. The target transaction is scheduled according to the magnitude relationship between the first weight and the second weight. Specifically, in a current round, for blockchain transactions that conflict with each other, a blockchain transaction with a largest weight is added to the transaction snapshot, and in a next round, a blockchain transaction with a smaller weight is re-executed. In addition, in the second round, after all blockchain transactions that need to be re-executed are completely re-executed, conflict detection is performed on the re-executed blockchain transactions. The re-executed blockchain transaction is equivalent to the target transaction in the first round. Therefore, the target transaction may be scheduled again according to a scheduling manner of the first round. It may be learned that, in the current round, if there are further blockchain transactions that conflict with each other, a blockchain transaction with a relatively small weight needs to be re-executed, and then the target transaction is scheduled again in a next round. Scheduling of the target transaction is completed until a round with blockchain transactions that do not conflict with each other is entered and the round ends. This is equivalent to that all the blockchain transactions are added to the transaction snapshot.

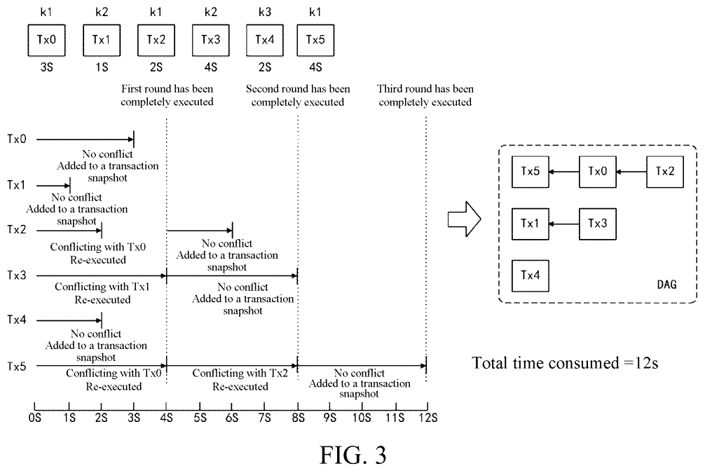

FIG. 3 is an exemplary schematic flowchart before deterministic scheduling optimization according to an embodiment of the present disclosure. A blockchain transaction that is first completely executed is added to the transaction snapshot according to a sequence of time when the blockchain transactions are completely executed, and a remaining blockchain transaction is re-executed. This may cause a blockchain transaction that consumes a large quantity of resources to be re-executed, thereby causing resource waste and reducing performance of the blockchain network.

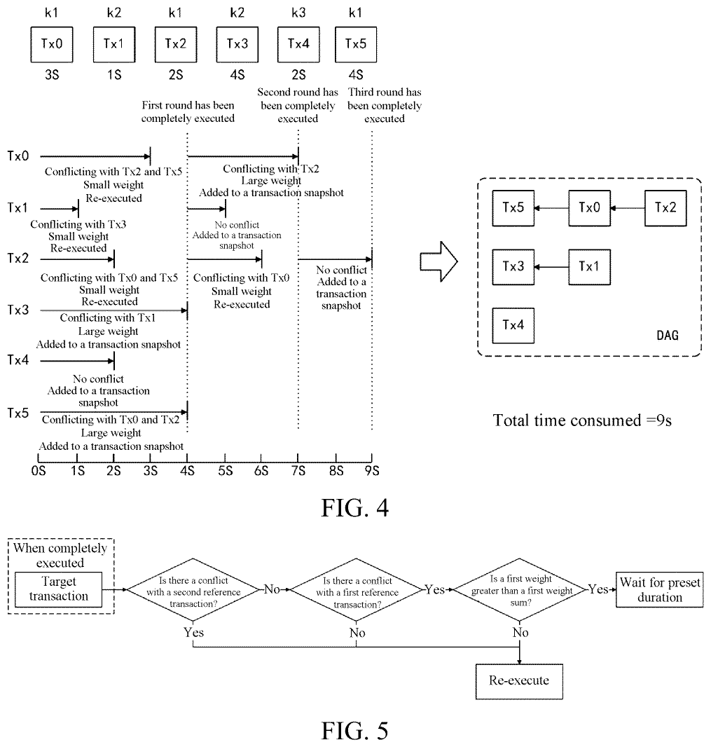

FIG. 4 is an exemplary schematic flowchart after deterministic scheduling optimization according to an embodiment of the present disclosure. Six blockchain transactions are executed in parallel, and the six blockchain transactions are respectively: Tx0, Tx1, Tx2, Tx3, Tx4, and Tx5. Execution time of Tx0 is 3 seconds, execution time of Tx1 is 1 second execution time of Tx2 is 2 seconds, execution time of Tx3 is 4 seconds, execution time of Tx4 is 2 seconds, execution time of Tx5 is 4 seconds. Preset duration is 1 second. Based on resources needing to be consumed for executing each blockchain transaction, it is determined that a weight of Tx0 is 30, a weight of Tx1 is 10, a weight of Tx2 is 20, a weight of Tx3 is 40, a weight of Tx4 is 20, and a weight of Tx5 is 40.

In the first round, when all blockchain transactions are completely executed, conflict detection is performed on each blockchain transaction. For example, Tx0 is used as a target transaction, and other blockchain transactions that are completely executed and that are not added to a transaction snapshot are used as first reference transactions. The first reference transactions include: Tx1, Tx2, Tx3, Tx4, and Tx5. A first conflict relationship between the target transaction and each first reference transaction is then determined. Read-write sets of Tx0, Tx2, and Tx5 all include a key k1, and read-write sets of Tx1, Tx3, and Tx4 do not include the key k1. After conflict detection, it can be determined that a conflict exists between Tx0 and Tx2, and a conflict exists between Tx0 and Tx5. Then, Tx0 is scheduled according to a magnitude relationship between the weight of Tx0 and the weight of Tx2, and Tx0 is scheduled according to a magnitude relationship between the weight of Tx0 and the weight of Tx5. Because the weight of Tx0 is less than the weight of Tx5, Tx0 is re-executed. Similarly, it can be determined to re-execute Tx2, and Tx5 is added to the transaction snapshot. Then, Tx1 is used as the target transaction. Both the read-write sets of Tx1 and Tx3 include a key k2. After conflict detection, it can be determined that a conflict exists between Tx1 and Tx3. Then, Tx1 is scheduled according to a magnitude relationship between the weight of Tx1 and the weight of Tx3. Because the weight of Tx1 is less than the weight of Tx3, Tx1 is re-executed. Similarly, Tx3 is added to the transaction snapshot. Then, Tx4 is used as the target transaction. The read-write set of Tx4 includes a key k3. After conflict detection, it can be determined that Tx4 does not conflict with another blockchain transaction, and Tx4 is added to the transaction snapshot.

In the second round, Tx0, Tx1, and Tx2 that are completely re-executed are scheduled, Tx0 and Tx1 are determined to be added to the transaction snapshot, and Tx2 is re-executed.

In the third round, the completely executed Tx2 is scheduled, and it can be determined to add Tx2 to the transaction snapshot. After the third round ends, all the blockchain transactions are added to the transaction snapshot, to complete scheduling of the target transaction.

It can be learned that, compared with total execution time of 12 seconds before deterministic scheduling optimization, total execution time after deterministic scheduling optimization is 9 seconds, and a reduction of 3 seconds leads to a 25% improvement in execution efficiency, which is a significant improvement in execution efficiency. In addition, retaining a blockchain transaction that consumes more resources and re-executing a blockchain transaction that consumes fewer resources avoid resource waste and improve performance of a blockchain network.

In addition, according to a scheduling result of the target transaction, a transaction directed acyclic graph (DAG) is constructed. Subsequently, the transaction directed acyclic graph and each blockchain transaction may be packaged to obtain a proposed block carrying the directed acyclic graph. Then, the proposed block is transmitted to a verification node in the blockchain network. The verification node can execute, based on the transaction directed acyclic graph, a blockchain transaction in the proposed block.

In one embodiment, the target transaction is obtained each time a blockchain transaction is completely executed, the first reference transaction is not added to the transaction snapshot, and the scheduling the target transaction according to a magnitude relationship between the first weight and the first weight sum may be specifically:
waiting for preset duration when the first weight is greater than the first weight sum, and scheduling the target transaction after waiting duration reaches the preset duration; or
re-executing the target transaction when the first weight is less than the first weight sum; or
waiting for preset duration when the first weight equals to the first weight sum, and scheduling the target transaction or re-executing the target transaction after waiting duration reaches the preset duration.

Transaction scheduling may be performed on the target transaction in a non-deterministic scheduling manner. In non-deterministic scheduling, an execution result of each blockchain transaction is non-deterministic. Non-deterministic scheduling uses specific execution time of the blockchain transaction as a determining standard. In non-deterministic scheduling, a time point of conflict detection is configured as follows: Each time a blockchain transaction is completely executed, conflict detection is performed on the blockchain transaction, to determine a conflict relationship between the blockchain transaction and a remaining completely executed blockchain transaction, where a result of conflict detection may be that no conflict exists between the blockchain transaction and the remaining completely executed blockchain transaction, or a result of conflict detection may be that a conflict exists between the blockchain transaction and the remaining completely executed blockchain transaction. When the result of conflict detection indicates that no conflict exists between the blockchain transaction and the remaining completely executed blockchain transaction, the blockchain transaction and the remaining completely executed blockchain transaction can be executed in parallel. When the result of conflict detection indicates that a conflict exists between the blockchain transaction and the remaining completely executed blockchain transaction, the blockchain transaction needs to be executed in series with the conflicting blockchain transaction.

For blockchain transactions that conflict with each other, only one of the blockchain transactions is retained, the blockchain transaction is added to the transaction snapshot, and a remaining blockchain transaction is re-executed. Execution time of different blockchain transactions may be different. Therefore, in non-deterministic scheduling, time points of conflict detection corresponding to different blockchain transactions may also be different, and the target transaction is obtained each time one of the blockchain transactions is completely executed.

Currently, when a plurality of blockchain transactions that conflict with each other is scheduled in the non-deterministic scheduling manner, a blockchain transaction that is first completely executed is added to the transaction snapshot according to a sequence of time when the blockchain transactions are completely executed, and a remaining blockchain transaction is re-executed. This may cause a blockchain transaction that consumes a large quantity of resources to be re-executed, thereby causing resource waste and reducing performance of the blockchain network.

Based on this, the scheduling method provided in this embodiment of the present disclosure can optimize non-deterministic scheduling. Non-deterministic scheduling may be applied to a pessimistic scenario. In the pessimistic scenario, one blockchain transaction is allowed to depend on a plurality of blockchain transactions at the same time. A first scheduling phase is entered when the target transaction is completely executed. In the first scheduling phase, when the target transaction is completely executed, the target transaction and the first reference transaction that conflict with each other are scheduled. First, a first weight of the target transaction and a second weight of the first reference transaction are obtained. There may be one or more first reference transactions. Therefore, different scheduling cases may be distinguished according to a quantity of the first reference transactions. Details are as follows:

Scheduling case 11: There is one first reference transaction, and the first weight sum is the second weight of the first reference transaction. The first weight and the second weight are both determined based on a resource consumption parameter. Therefore, scheduling the target transaction according to the magnitude relationship between the first weight and the first weight sum is equivalent to scheduling the target transaction according to the resource consumption parameter. The resource consumption parameter is configured for indicating a resource required for executing a blockchain transaction, the first weight is configured for indicating a resource required for executing the target transaction, and the second weight is configured for indicating a resource required for executing the first reference transaction. When the resource required for executing the target transaction is relatively small, the first weight is relatively small. Otherwise, when the resource required for executing the target transaction is relatively large, the first weight is relatively large. Similarly, when the resource required for executing the first reference transaction is relatively small, the first weight sum is relatively small. Otherwise, when the resource required for executing the first reference transaction is relatively large, the first weight sum is relatively large.

Scheduling case 12: There are a plurality of first reference transactions, and when the target transaction is completely executed, any two first reference transactions do not conflict with each other. All the first reference transactions may be used as a first reference set, and second weights of all the first reference transactions need to be summed, which is equivalent to obtaining a first weight sum corresponding to the first reference set. Because both the first weight and the second weight are determined based on the resource consumption parameter, scheduling the target transaction according to the magnitude relationship between the first weight and the first weight sum is equivalent to scheduling the target transaction according to the resource consumption parameter. The resource consumption parameter is configured for indicating a resource required for executing a blockchain transaction. The first weight is configured for indicating a resource required for executing the target transaction. The second weight is configured for indicating a resource required for executing the first reference transaction. When the resource required for executing the target transaction is relatively small, the first weight is relatively small. Otherwise, when the resource required for executing the target transaction is relatively large, the first weight is relatively large. Similarly, when resources required for executing all the first reference transactions in the first reference set are relatively small, the first weight sum is relatively small. Otherwise, when the resources required for executing all the first reference transactions in the first reference set are relatively large, the first weight sum is relatively large.

For example, a first reference transaction 1, a first reference transaction 2, and a first reference transaction 3 are all configured for processing state data corresponding to the same key, execution time of the first reference transaction 1 is 1 second, execution time of the first reference transaction 2 is 2 seconds, and execution time of the first reference transaction 3 is 3 seconds. The first reference transaction 1 and the first reference transaction 2 are concurrently executed at the same time. When 1 second is reached, the first reference transaction 1 is completely executed, the first reference transaction 1 is used as the target transaction, it is determined through conflict detection that the first reference transaction 1 does not conflict with remaining blockchain transactions, the first reference transaction 1 is retained, and at this time, the first reference transaction 3 starts to be executed. When 2 seconds are reached, the first reference transaction 2 is completely executed, the first reference transaction 2 is used as the target transaction, it is determined through conflict detection that the first reference transaction 2 and the first reference transaction 1 conflict, and a weight magnitude relationship between the first reference transaction 2 and the first reference transaction 1 is further determined. Assuming that a weight of the first reference transaction 2 is larger, the first reference transaction 1 is re-executed, and the first reference transaction 1 is retained. When 3 seconds are reached, the first reference transaction 1 is completely re-executed, the first reference transaction 1 is used as the target transaction, it is determined through conflict detection that the first reference transaction 1 does not conflict with the remaining blockchain transactions, and the first reference transaction 1 is retained. When 4 seconds are reached, the first reference transaction 3 is completely executed, the first reference transaction 3 is used as the target transaction, and it is determined through conflict detection that the first reference transaction 3 conflicts with the remaining blockchain transactions. Because there is no conflict between the first reference transaction 1 and the first reference transaction 2 when the first reference transaction 3 is completely executed, the first reference transaction 1 and the first reference transaction 2 are used as a first reference set. It is assumed that a weight of the first reference transaction 1 is 100, a weight of the first reference transaction 2 is 200, and a weight of the first reference transaction 3 is 250. The weights of the first reference transaction 1 and the first reference transaction 2 are summed, to obtain a first weight sum of the first reference set as 300. A magnitude relationship between the first weight and the first weight sum is compared. Because 250<300, the first reference transaction 3 is re-executed, and the first reference transaction 1 and the first reference transaction 2 are retained, so that a blockchain transaction that consumes a large quantity of resources is retained, and a blockchain transaction that consumes a small quantity of resources is re-executed, thereby avoiding resource waste and improving performance of the blockchain network.

Based on this, in the pessimistic scenario, one blockchain transaction is allowed to simultaneously depend on a plurality of blockchain transactions. Therefore, when the target transaction is completely executed, some blockchain transactions on which the target transaction depends may not be completely executed. By setting the preset duration and waiting, each blockchain transaction on which the target transaction depends can be completely executed. In this way, a scheduling result of the target transaction is more accurate, thereby improving certainty of the execution result. Specifically, a second scheduling phase is entered if the target transaction does not need to be re-executed in the first scheduling phase, and in the second scheduling phase, after the preset duration is reached, the target transaction is scheduled, so that when the target transaction is scheduled, a blockchain transaction that consumes a relatively large quantity of resources can be retained, and a blockchain transaction that consumes a relatively small quantity of resources can be re-executed, thereby avoiding resource waste and improving performance of the blockchain network.

Different blockchain transactions may correspond to different preset duration. However, it needs to be ensured that each node sets the preset duration according to the same delay rule. For example, corresponding preset duration is set according to a contract. It is required that all nodes have the same preset duration for the same contract.

In one embodiment, the determining a first conflict relationship between the target transaction and the at least one first reference transaction may be specifically: determining a second conflict relationship between the target transaction and a second reference transaction, the second reference transaction being a blockchain transaction that is other than the target transaction, that is currently completely executed, and that has been added to the transaction snapshot; and determining the first conflict relationship between the target transaction and the at least one first reference transaction when the second conflict relationship indicates that no conflict exists between the target transaction and the second reference transaction.

The second conflict relationship is configured for indicating whether a conflict exists between the target transaction and the second reference transaction.

Based on this, in the first scheduling phase, whether the target transaction and the second reference transaction have a conflict needs to be determined first, which is equivalent to determining whether the target transaction and the blockchain transaction that is currently added to the transaction snapshot have a conflict. If the target transaction and the blockchain transaction that is currently added to the transaction snapshot have a conflict, the target transaction is re-executed. Subsequently, the magnitude relationship between the first weight and the first weight sum does not need to be determined, thereby improving scheduling efficiency of the blockchain transaction, and further improving execution efficiency of the blockchain transaction.

FIG. 5 is an exemplary schematic flowchart of a first scheduling phase according to an embodiment of the present disclosure. Three times of determining need to be performed in sequence. In the first time of determining, whether a conflict exists between the target transaction and the second reference transaction is determined by using the second conflict relationship; if it is determined that a conflict exists between the target transaction and the second reference transaction, the target transaction is re-executed; otherwise, the second time of determining is performed. In the second time of determining, whether a conflict exists between the target transaction and the first reference transaction is determined by using the first conflict relationship; if it is determined that no conflict exists between the target transaction and the first reference transaction, the target transaction is re-executed; if it is determined that a conflict exists between the target transaction and the first reference transaction, the third time of determining is performed. In the third time of determining, whether the first weight is greater than the first weight sum is determined, and when the first weight is greater than the first weight sum, the second scheduling phase is entered. Waiting for the preset duration is performed in the second scheduling phase. When the first weight is less than the first weight sum, the target transaction is re-executed. When the first weight equals to the first weight sum, the second scheduling phase may be entered or the target transaction may be selected to be re-executed. A selection to re-execute the target transaction is provided in the figure.

When execution of the blockchain transaction starts, a current transaction quantity in the transaction snapshot is used as a first reference quantity. The current transaction quantity in the transaction snapshot is a quantity of blockchain transactions included in the transaction snapshot. After corresponding transaction execution time passes, the blockchain transaction is completely executed. When the blockchain transaction is completely executed, the blockchain transaction is used as the target transaction, the current transaction quantity in the transaction snapshot is used as a second reference quantity, and the first reference quantity is compared with the second reference quantity. When the first reference quantity is the same as the second reference quantity, there is no second reference transaction for the target transaction. Otherwise, there is a second reference transaction for the target transaction.

On the contrary, in another embodiment, in the first scheduling phase, whether a conflict exists between the target transaction and the second reference transaction may not be determined. Compared with the case that whether a conflict exists between the target transaction and the second reference transaction needs to be determined, a relatively large amount of time is consumed in the scheduling process, but the consumed time is much less than time consumed for re-executing a blockchain transaction that consumes a relatively large quantity of resources. Therefore, when the target transaction is scheduled, a blockchain transaction that consumes a relatively large quantity of resources may be retained, and a blockchain transaction that consumes a relatively small quantity of resources may be re-executed, thereby avoiding resource waste and improving performance of the blockchain network.

In one embodiment, the scheduling the target transaction after the waiting time reaches preset duration may be specifically: determining a third conflict relationship between the target transaction and at least one third reference transaction after the waiting duration reaches the preset duration, the third reference transaction being a blockchain transaction that is other than the target transaction, that is currently completely executed, and that is not added to the transaction snapshot; obtaining a third weight of the third reference transaction when the third conflict relationship indicates that a conflict exists between the target transaction and the third reference transaction, the third weight being determined based on a resource consumption parameter during execution of the third reference transaction; and calculating a sum of third weights as a second weight sum, and scheduling the target transaction according to a magnitude relationship between the first weight and the second weight sum.

The third conflict relationship is configured for indicating whether a conflict exists between the target transaction and the third reference transaction. The magnitude relationship between the first weight and the second weight sum means that the first weight is greater than the second weight sum, or the first weight is less than the second weight sum, or the first weight equals to the second weight sum.

Based on this, when it is determined to wait for the preset duration in the first scheduling phase, that is, it is determined to enter the second scheduling phase, waiting for the preset duration is performed in the second scheduling phase. After the preset duration is reached, the target transaction and the third reference transaction that conflict with each other are scheduled. The first weight of the target transaction and the third weight of the third reference transaction are first obtained. A quantity of third reference transactions may be one or more. Therefore, different scheduling cases may be distinguished according to the quantity of third reference transactions. Details are as follows:

Scheduling case 13: There is one third reference transaction, and the second weight sum is the third weight of the third reference transaction. The first weight and the third weight are both determined based on a resource consumption parameter. Therefore, scheduling the target transaction according to the magnitude relationship between the first weight and the second weight sum is equivalent to scheduling the target transaction according to the resource consumption parameter. The resource consumption parameter is configured for indicating a resource required for executing a blockchain transaction, the first weight is configured for indicating a resource required for executing the target transaction, and the third weight is configured for indicating a resource required for executing the third reference transaction. When the resource required for executing the target transaction is relatively small, the first weight is relatively small. Otherwise, when the resource required for executing the target transaction is relatively large, the first weight is relatively large. Similarly, when the resource required for executing the third reference transaction is relatively small, the second weight sum is relatively small. Otherwise, when the resource required for executing the third reference transaction is relatively large, the second weight sum is relatively large.

Scheduling case 14: There is a plurality of third reference transactions, and when the target transaction is completely executed, any two third reference transactions do not conflict with each other. All the third reference transactions may be used as a second reference set. Similar to the scheduling case 12, third weights of all the third reference transactions need to be summed, which is equivalent to obtaining a second weight sum corresponding to the second reference set. Because the first weight and the third weight are both determined based on the resource consumption parameter, scheduling the target transaction according to the magnitude relationship between the first weight and the second weight sum is equivalent to scheduling the target transaction according to the resource consumption parameter. The resource consumption parameter is configured for indicating a resource required for executing a blockchain transaction. The first weight is configured for indicating a resource required for executing the target transaction. The third weight is configured for indicating a resource required for executing the third reference transaction. When the resource required for executing the target transaction is relatively small, the first weight is relatively small. Otherwise, when the resource required for executing the target transaction is relatively large, the first weight is relatively large. Similarly, when resources required for executing all the third reference transactions in the second reference set are relatively small, the second weight sum is relatively small. Otherwise, when the resources required for executing all the third reference transactions in the second reference set are relatively large, the second weight sum is relatively large.

In addition, relative to the scheduling case 14, a scheduling case 15 may further exist.

Scheduling case 15: There is a plurality of third reference transactions, and when the target transaction is completely executed, the third reference transactions conflict with each other. In a transaction set formed by the target transaction and the third reference transactions, a blockchain transaction having a largest weight is retained, and a blockchain transaction having a smaller weight is re-executed.

In one embodiment, the scheduling the target transaction according to a magnitude relationship between the first weight and the second weight sum may be specifically:
adding the target transaction to the transaction snapshot when the first weight is greater than the second weight sum; or
re-executing the target transaction when the first weight is less than the second weight sum; or
adding the target transaction to the transaction snapshot or re-executing the target transaction when the first weight equals to the second weight sum.

Based on this, for the three comparison cases of the first weight and the second weight sum, when the first weight is greater than the second weight sum, the target transaction is retained and is added to the transaction snapshot; when the first weight is less than the second weight sum, the target transaction is re-executed; and when the first weight equals to the second weight sum, the target transaction may be added to the transaction snapshot, or the target transaction may be re-executed, so that when the target transaction is scheduled, a blockchain transaction with relatively high resource consumption is retained, and a blockchain transaction with relatively low resource consumption is re-executed, thereby avoiding resource waste and improving performance of the blockchain network.

In one embodiment, the determining a third conflict relationship between the target transaction and at least one third reference transaction may be specifically: determining a fourth conflict relationship between the target transaction and a fourth reference transaction, the fourth reference transaction being a blockchain transaction that is other than the target transaction, that is currently completely executed, and that has been added to the transaction snapshot; and determining the third conflict relationship between the target transaction and the at least one third reference transaction when the fourth conflict relationship indicates that no conflict exists between the target transaction and the fourth reference transaction.

The fourth conflict relationship is configured for indicating whether a conflict exists between the target transaction and the fourth reference transaction.

Based on this, in the second scheduling phase, whether the target transaction and the fourth reference transaction have a conflict needs to be determined first, which is equivalent to determining whether the target transaction and the blockchain transaction that is currently added to the transaction snapshot have a conflict. If the target transaction and the blockchain transaction that is currently added to the transaction snapshot have a conflict, the target transaction is re-executed. Subsequently, the magnitude relationship between the first weight and the second weight sum does not need to be determined, thereby improving scheduling efficiency of the blockchain transaction, and further improving execution efficiency of the blockchain transaction.

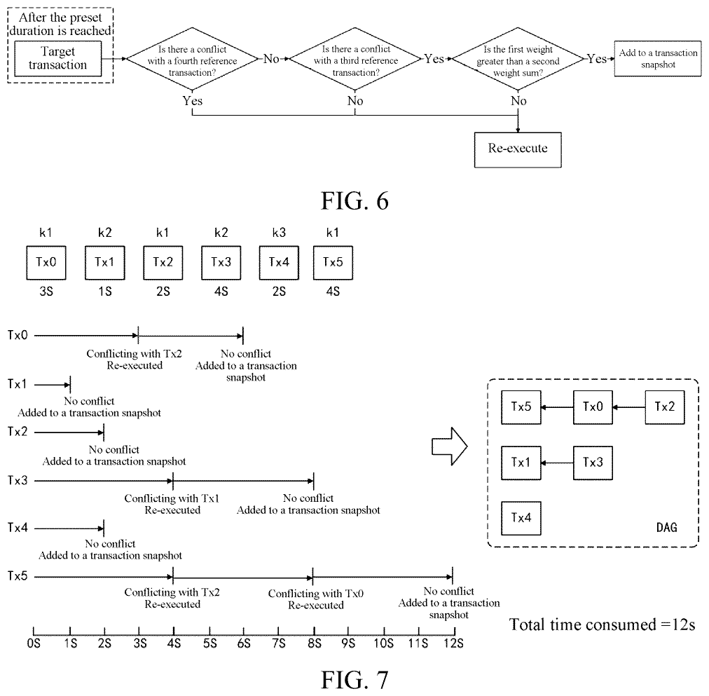

FIG. 6 is an exemplary schematic flowchart of a second scheduling phase according to an embodiment of the present disclosure. Three times of determining need to be performed in sequence. In the first time of determining, whether a conflict exists between the target transaction and the fourth reference transaction is determined by using the fourth conflict relationship; if it is determined that a conflict exists between the target transaction and the second reference transaction, the target transaction is re-executed; otherwise, the second time of determining is performed. In the second time of determining, whether a conflict exists between the target transaction and the third reference transaction is determined by using the third conflict relationship; if it is determined that no conflict exists between the target transaction and the first reference transaction, the target transaction is re-executed; otherwise, the third time of determining is performed. In the third time of determining, whether the first weight is greater than the second weight sum is determined, when the first weight is greater than the second weight sum, the target transaction is added to the transaction snapshot. When the first weight is less than the second weight sum, the target transaction is re-executed. When the first weight equals to the second weight sum, the target transaction may be added to the transaction snapshot or re-executed. A selection to re-execute the target transaction is provided in the figure.

When the target transaction is completely executed, the current transaction quantity in the transaction snapshot is used as the second reference quantity. After corresponding preset duration passes, the target transaction reaches the preset duration. When the target transaction reaches the preset duration, the current transaction quantity in the transaction snapshot is used as a third reference quantity, and the second reference quantity is compared with the third reference quantity. When the second reference quantity is the same as the third reference quantity, the fourth reference transaction does not exist for the target transaction; otherwise, the fourth reference transaction exists for the blockchain transaction.

On the contrary, in another embodiment, in the second scheduling phase, whether a conflict exists between the target transaction and the fourth reference transaction may not be determined. Compared with the case that whether a conflict exists between the target transaction and the fourth reference transaction needs to be determined, a relatively large amount of time is consumed in the scheduling process, but the consumed time is much less than time consumed for re-executing a blockchain transaction that consumes a relatively large quantity of resources. Therefore, when the target transaction is scheduled, a blockchain transaction that consumes a relatively large quantity of resources may be retained, and a blockchain transaction that consumes a relatively small quantity of resources may be re-executed, thereby avoiding resource waste and improving performance of the blockchain network.

In one embodiment, the scheduling method for a blockchain transaction further includes:
using, when blockchain transactions not added to the transaction snapshot are completely re-executed, a blockchain transaction that is completely re-executed and that is not added to the transaction snapshot as the target transaction; and
scheduling the target transaction again, until all the blockchain transactions are added to the transaction snapshot.

Transaction scheduling may be performed on the target transaction in a non-deterministic scheduling manner. In non-deterministic scheduling, an execution result of each blockchain transaction is non-deterministic. Non-deterministic scheduling may be applied to a pessimistic scenario. In the pessimistic scenario, one blockchain transaction is allowed to depend on a plurality of blockchain transactions simultaneously. Non-deterministic scheduling uses specific execution time of the blockchain transaction as a determining standard. In non-deterministic scheduling, a time point of conflict detection is configured as follows: Each time a blockchain transaction is completely executed, conflict detection is performed on the blockchain transaction, to determine a conflict relationship between the blockchain transaction and a remaining completely executed blockchain transaction. Therefore, when the blockchain transaction is completely re-executed, conflict detection needs to be performed on the blockchain transaction again, to determine a conflict relationship between the blockchain transaction and the remaining executed blockchain transaction. When all the blockchain transactions are added to the transaction snapshot, scheduling on the target transaction is completed.

FIG. 7 is an exemplary schematic flowchart before non-deterministic scheduling optimization according to an embodiment of the present disclosure. A blockchain transaction that is first completely executed is added to the transaction snapshot according to a sequence of time when the blockchain transactions are completely executed, and a remaining blockchain transaction is re-executed. This may cause a blockchain transaction that consumes a large quantity of resources to be re-executed, thereby causing resource waste and reducing performance of the blockchain network.

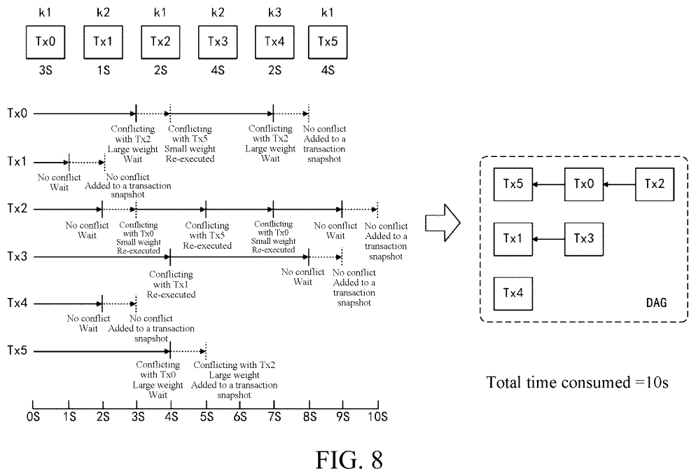

FIG. 8 is an exemplary schematic flowchart after non-deterministic scheduling optimization according to an embodiment of the present disclosure. In non-deterministic scheduling, each time a blockchain transaction is completely executed, conflict detection is performed on the blockchain transaction, to determine a conflict relationship between the blockchain transaction and a remaining completely executed blockchain transaction. In addition, in the pessimistic scenario, one blockchain transaction is allowed to simultaneously depend on a plurality of blockchain transactions. Therefore, when the target transaction is completely executed, some blockchain transactions on which the target transaction depends may not be completely executed. By setting the preset duration and waiting, each blockchain transaction on which the target transaction depends can be completely executed. In this way, a scheduling result of the target transaction is more accurate, thereby improving certainty of the execution result.

Specifically, six blockchain transactions are executed in parallel, and the six blockchain transactions are respectively: Tx0, Tx1, Tx2, Tx3, Tx4, and Tx5. Execution time of Tx0 is 3 seconds, execution time of Tx1 is 1 second execution time of Tx2 is 2 seconds, execution time of Tx3 is 4 seconds, execution time of Tx4 is 2 seconds, execution time of Tx5 is 4 seconds. Preset duration is 1 second. Based on resources needing to be consumed for executing each blockchain transaction, it can be determined that a weight of Tx0 is 30, a weight of Tx1 is 10, a weight of Tx2 is 20, a weight of Tx3 is 40, a weight of Tx4 is 20, and a weight of Tx5 is 40.

When 1 second is reached, Tx1 is completely executed. Tx1 is used as the target transaction. In the first scheduling phase, it is determined through conflict detection that Tx1 does not conflict with remaining blockchain transactions. Tx1 enters the second scheduling phase, and Tx1 waits for the preset duration in the second scheduling phase.

When 2 seconds are reached, Tx1 reaches the preset duration, and in the second scheduling phase, it is determined through conflict detection that Tx1 does not conflict with the remaining blockchain transactions, and Tx1 is added to the transaction snapshot. At the same time, Tx2 is completely executed, Tx2 is used as the target transaction, and it is determined through conflict detection in the first scheduling phase that Tx2 does not conflict with the remaining blockchain transactions, Tx2 enters the second scheduling phase, and Tx2 waits for the preset duration in the second scheduling phase. At the same time, Tx4 is completely executed. Tx4 is used as the target transaction. In the first scheduling phase, it is determined through conflict detection that Tx4 does not conflict with the remaining blockchain transactions. Tx4 enters the second scheduling phase, and Tx4 waits for the preset duration in the second scheduling phase.

When 3 seconds are reached, Tx0 is completely executed, and Tx0 is used as the target transaction. Conflict detection is performed in the first scheduling phase. Because both read-write sets of Tx0 and Tx2 include a key k1, and Tx2 is completely executed and is not added to the transaction snapshot, it is determined that Tx2 is the first reference transaction that conflicts with Tx1. Tx0 is scheduled according to a magnitude relationship between the weight of Tx0 and the weight of Tx2. Because the weight of Tx0 is greater than the weight of Tx2, Tx0 enters the second scheduling phase, and Tx0 waits for the preset duration in the second scheduling phase. At the same time, Tx2 reaches the preset duration. In the second scheduling phase, it is determined through conflict detection that Tx0 is the third reference transaction that conflicts with Tx2. Tx2 is scheduled according to a magnitude relationship between the weight of Tx2 and the weight of Tx0. Because the weight of Tx2 is less than the weight of Tx0, Tx2 is re-executed. At the same time, Tx4 reaches the preset duration. In the second scheduling phase, it is determined through conflict detection that Tx4 does not conflict with the remaining blockchain transactions, and Tx4 is added to the transaction snapshot.

When 4 seconds is reached, Tx0 reaches the preset duration. Conflict detection is performed in the second scheduling phase. Because both read-write sets of Tx0 and Tx5 include a key k1, and Tx5 is completely executed and is not added to the transaction snapshot, it is determined that Tx5 is the third reference transaction that conflicts with Tx0. Tx0 is scheduled according to a magnitude relationship between the weight of Tx0 and the weight of Tx5. Because the weight of Tx0 is less than the weight of Tx5, Tx0 is re-executed. At the same time, Tx3 is completely executed, Tx3 is used as the target transaction, and conflict detection is performed in the first scheduling phase. Because both read-write sets of Tx3 and Tx1 include a key k2, and Tx1 has been added to the transaction snapshot, it is determined that Tx1 is the second reference transaction that conflicts with Tx3, and Tx3 is re-executed. At the same time, Tx5 is completely executed. Tx5 is used as the target transaction. In the first scheduling phase, it is determined through conflict detection that Tx0 is the first reference transaction that conflicts with Tx5. Tx5 is scheduled according to a magnitude relationship between the weight of Tx5 and the weight of Tx0. Because the weight of Tx5 is greater than the weight of Tx0, Tx5 waits for the preset duration in the second scheduling phase.

When 5 seconds is reached, Tx2 is re-executed. Tx2 is used as the target transaction. In the first scheduling phase, it is determined through conflict detection that Tx5 is the first reference transaction that conflicts with Tx2. Tx2 is scheduled according to a magnitude relationship between the weight of Tx2 and the weight of Tx5. Because the weight of Tx2 is less than the weight of Tx5, Tx2 is re-executed. At the same time, Tx5 reaches the preset duration. In the second scheduling phase, it is determined through conflict detection that Tx2 is the third reference transaction that conflicts with Tx5. Tx5 is scheduled according to a magnitude relationship between the weight of Tx5 and the weight of Tx2. Because the weight of Tx5 is greater than the weight of Tx2, Tx5 is added to the transaction snapshot.

When 7 seconds are reached, Tx0 is completely re-executed. Tx0 is used as the target transaction. In the first scheduling phase, it is determined through conflict detection that Tx2 is the first reference transaction that conflicts with Tx0. Tx0 is scheduled according to a magnitude relationship between the weight of Tx0 and the weight of Tx2. Because the weight of Tx0 is greater than the weight of Tx2, Tx0 enters the second scheduling phase, and Tx0 waits for the preset duration in the second scheduling phase. At the same time, Tx2 is completely re-executed. Tx2 is used as the target transaction. In the first scheduling phase, it is determined through conflict detection that Tx0 is the first reference transaction that conflicts with Tx2. Tx2 is scheduled according to a magnitude relationship between the weight of Tx2 and the weight of Tx0. Because the weight of Tx2 is less than the weight of Tx0, Tx2 is re-executed.

When 8 seconds are reached, Tx0 reaches the preset duration, it is determined through conflict detection in the second scheduling phase that Tx0 does not conflict with the remaining blockchain transactions, and Tx0 is added to the transaction snapshot. At the same time, Tx3 is completely executed, Tx3 is used as the target transaction, and it is determined through conflict detection in the first scheduling phase that Tx3 does not conflict with the remaining blockchain transactions, Tx3 enters the second scheduling phase, and Tx3 waits for the preset duration in the second scheduling phase.

When 9 seconds are reached, Tx2 is completely executed, Tx2 is used as the target transaction, and it is determined through conflict detection in the first scheduling phase that Tx2 does not conflict with the remaining blockchain transactions, Tx2 enters the second scheduling phase, and Tx2 waits for the preset duration in the second scheduling phase. At the same time, Tx3 reaches the preset duration, it is determined through conflict detection in the second scheduling phase that Tx3 does not conflict with the remaining blockchain transactions, and Tx3 is added to the transaction snapshot. When 10 seconds are reached, Tx2 reaches the preset duration, it is determined through conflict detection in the second scheduling phase that Tx2 does not conflict with the remaining blockchain transactions, and Tx2 is added to the transaction snapshot.

It can be learned that, compared with total execution time of 12 seconds before non-deterministic scheduling optimization, total execution time after non-deterministic scheduling optimization for the pessimistic scenario is 10 seconds, and a reduction of 2 seconds leads to a near 17% improvement in execution efficiency, which is a significant improvement in execution efficiency. In addition, retaining a blockchain transaction that consumes more resources and re-executing a blockchain transaction that consumes fewer resources avoid resource waste and improve performance of a blockchain network.

In addition, according to a scheduling result of the target transaction, a transaction directed acyclic graph is constructed. The transaction directed acyclic graph and each blockchain transaction are packaged to obtain a proposed block carrying the directed acyclic graph. Then, the proposed block is transmitted to a verification node in the blockchain network. The verification node can execute, based on the transaction directed acyclic graph, a blockchain transaction in the proposed block.

In one embodiment, the preset duration may be further optimized. For example, the preset duration may be optimized by using a block-by-block optimization method. A block having a highest block height in a blockchain is used as an initial block, and initial preset duration is set for the initial block. A corresponding blockchain transaction is scheduled according to the initial preset duration, then the blockchain transaction is executed, total execution time is determined, and the preset duration is optimized according to the total execution time. In a next block of the initial block, a corresponding blockchain transaction is scheduled according to the optimized preset duration, then the blockchain transaction is executed, and the preset duration may be optimized again according to the total execution time. Therefore, the preset duration can be continuously optimized to obtain optimal preset duration, which can effectively improve execution efficiency. Optimizing the preset duration may be lengthening the preset duration, or shortening the preset duration according to an actual situation.

In addition, the preset duration may alternatively be optimized by using a simulation training method. A block having a highest block height in a blockchain is used as an initial block, and preset duration is preset for the initial block. Then, a batch of blockchain transactions are selected from a transaction pool as sample transactions. The corresponding sample transactions are scheduled based on the initial block according to the initial preset duration. Then, the sample transactions are executed, and total execution time is determined. Then, optimized preset duration is determined based on the total execution time. Then, the corresponding sample transactions are scheduled based on the initial block according to the optimized preset duration. Then, the sample transactions are executed, and the total execution time is determined. The preset duration may be optimized again by using the total execution time. Therefore, the preset duration may be continuously optimized to obtain optimal preset duration, which can effectively improve execution efficiency.

In one embodiment, the target transaction is obtained each time a blockchain transaction is completely executed, the first reference transaction has been added to the transaction snapshot, and the scheduling the target transaction according to a magnitude relationship between the first weight and the first weight sum may be specifically:
replacing the first reference transaction in the transaction snapshot with the target transaction when the first weight is greater than the first weight sum; or
re-executing the target transaction when the first weight is less than the first weight sum; or
replacing the first reference transaction in the transaction snapshot with the target transaction or re-executing the target transaction when the first weight equals to the first weight sum.

Based on this, the scheduling method provided in this embodiment of the present disclosure can further optimize non-deterministic scheduling in an optimistic scenario. In the optimistic scenario, a quantity of blockchain transactions that one blockchain transaction depends on is less than or equal to one. When conflicting blockchain transactions are executed in series, each blockchain transaction only depends on a previous blockchain transaction, and does not depend on a plurality of blockchain transactions simultaneously. Exchanging execution sequences of the blockchain transactions does not affect a final execution result. Therefore, in the optimistic scenario, conflicting transactions are allowed to be replaced. Specifically, when a blockchain transaction is completely executed, if there is no conflict transaction conflicting with the blockchain transaction in the transaction snapshot, the blockchain transaction may be temporarily added to the transaction snapshot, or there is a conflict transaction conflicting with the blockchain transaction in the transaction snapshot. When replacement is needed, the conflict transaction in the transaction snapshot may be replaced with the blockchain transaction, and the conflict transaction is re-executed. Therefore, in an optimistic scenario, the first reference transaction is a blockchain transaction that has been added to the transaction snapshot.

When the target transaction is completely executed, the target transaction and the first reference transaction that conflict with each other are scheduled. First, a first weight of the target transaction and a second weight of the first reference transaction are obtained. There may be one or more first reference transactions. Therefore, different scheduling cases may be distinguished according to a quantity of the first reference transactions. Details are as follows:

Scheduling case 21: There is one first reference transaction, and the first weight sum is the second weight of the first reference transaction. The first weight and the second weight are both determined based on a resource consumption parameter. Therefore, scheduling the target transaction according to the magnitude relationship between the first weight and the first weight sum is equivalent to scheduling the target transaction according to the resource consumption parameter. The resource consumption parameter is configured for indicating a resource required for executing a blockchain transaction, the first weight is configured for indicating a resource required for executing the target transaction, and the second weight is configured for indicating a resource required for executing the first reference transaction. When the resource required for executing the target transaction is relatively small, the first weight is relatively small. Otherwise, when the resource required for executing the target transaction is relatively large, the first weight is relatively large. Similarly, when the resource required for executing the first reference transaction is relatively small, the first weight sum is relatively small. Otherwise, when the resource required for executing the first reference transaction is relatively large, the first weight sum is relatively large.

Specifically, when a plurality of blockchain transactions configured for processing state data corresponding to the same key are executed in parallel, and time points at which the blockchain transactions are completely executed do not overlap, the first completely executed blockchain transaction is temporarily added to the transaction snapshot, weight comparison is performed on a later completely executed blockchain transaction and a blockchain transaction in the transaction snapshot, and whether replacement needs to be performed is determined according to a weight comparison result. If time points at which some blockchain transactions are completely executed overlap, a blockchain transaction on which conflict detection is performed first does not use a blockchain transaction on which conflict detection is performed later as a conflict transaction. For example, two blockchain transactions are executed concurrently, and the blockchain transactions are completely executed at the same time, one of the blockchain transactions is used as the target transaction, and conflict detection is performed on the target transaction. Because the other blockchain transaction is not used as a conflict transaction, the blockchain transaction on which conflict detection is performed first is directly added to the transaction snapshot, which is equivalent to that a quantity of first reference transactions is zero. Then the other blockchain transaction is used as the target transaction, and conflict detection is performed on the target transaction. Weight comparison is performed between the other blockchain transaction and a blockchain transaction of the transaction snapshot. Whether replacement is required is determined according to a weight comparison result. This is equivalent to that the quantity of first reference transactions is one. Similarly, if time points at which three or more blockchain transactions are completely executed overlap, only a blockchain transaction that has been added to the transaction snapshot is used as the first reference transaction.

In addition, according to a scheduling result of the target transaction, a transaction directed acyclic graph is constructed. The transaction directed acyclic graph and each blockchain transaction are packaged to obtain a proposed block carrying the directed acyclic graph. Then, the proposed block is transmitted to a verification node in the blockchain network. The verification node can execute, based on the transaction directed acyclic graph, a blockchain transaction in the proposed block.

Scheduling case 22: There are a plurality of first reference transactions, and the plurality of first reference transactions have been added to the transaction snapshot. All the first reference transactions may be used as a third reference set, and second weights of all the first reference transactions need to be summed, which is equivalent to obtaining a first weight sum of the third reference set. Because both the first weight and the second weight are determined based on the resource consumption parameter, scheduling the target transaction according to the magnitude relationship between the first weight and the first weight sum is equivalent to scheduling the target transaction according to the resource consumption parameter. The resource consumption parameter is configured for indicating a resource required for executing a blockchain transaction. The first weight is configured for indicating a resource required for executing the target transaction. The second weight is configured for indicating a resource required for executing the first reference transaction. When the resource required for executing the target transaction is relatively small, the first weight is relatively small. Otherwise, when the resource required for executing the target transaction is relatively large, the first weight is relatively large. Similarly, when resources required for executing all the first reference transactions in the third reference set are relatively small, the first weight sum is relatively small. Otherwise, when the resources required for executing all the first reference transactions in the third reference set are relatively large, the first weight sum is relatively large.

Because system scheduling exists, system scheduling may cause a case in which not all blockchain transactions are started completely in parallel, and system scheduling refers to scheduling performed by an operating system for a program. In this case, when a later executed blockchain transactions is completely executed, all first reference transactions that are executed first and that are completely executed may be used as objects for weight comparison, to calculate a first weight sum of all second weights, and by comparing the first weight with the first weight sum, whether resource consumption of executing the target transaction is greater than resource consumption corresponding to execution of all the first reference transactions that are executed first and that are completely executed can be effectively determined. Further, a blockchain transaction that consumes more resources is retained, and a blockchain transaction that consumes fewer resources is re-executed, thereby avoiding resource waste and improving performance of the blockchain network.

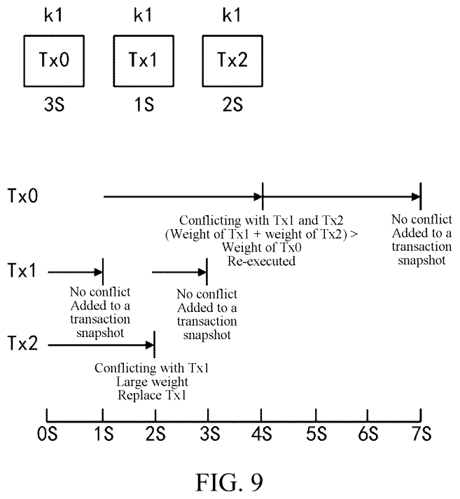

FIG. 9 is another exemplary schematic flowchart after non-deterministic scheduling optimization according to an embodiment of the present disclosure. Three blockchain transactions are executed in parallel, and the three blockchain transactions are respectively: Tx0, Tx1, and Tx2. Execution time of Tx0 is 3 seconds, execution time of Tx1 is 1 second, and execution time of Tx2 is 2 seconds. Based on resources that need to be consumed for executing each blockchain transaction, it can be determined that a weight of Tx0 is 25, a weight of Tx1 is 10, and a weight of Tx2 is 20.

When 1 second is reached, Tx1 is completely executed, Tx1 is used as the target transaction, it is determined through conflict detection that Tx1 does not conflict with remaining blockchain transactions, and Tx1 is added to the transaction snapshot. At the same time, because of system scheduling reasons, Tx0 starts to be executed.

When 2 seconds are reached, Tx2 is completely executed, Tx2 is used as the target transaction. Through conflict detection, it is determined that Tx1 is the first reference transaction that conflicts with Tx2. Tx2 is scheduled according to a magnitude relationship between the weight of Tx1 and the weight of Tx2. Because the weight of Tx2 is greater than the weight of Tx1, Tx1 in the transaction snapshot is replaced with Tx2, that is, Tx2 is added to the transaction snapshot, and Tx1 is re-executed.

When 3 seconds are reached, Tx1 is re-executed, Tx1 is used as the target transaction, it is determined through conflict detection that Tx1 does not conflict with the remaining blockchain transactions, and Tx1 is added to the transaction snapshot.

When 4 seconds is reached, Tx0 is completely executed, Tx0 is used as the target transaction, and it is determined through conflict detection that both Tx1 and Tx2 are first reference transactions that conflict with Tx0. Tx1 and Tx2 do not conflict with each other, and therefore, Tx1 and Tx2 are used as a third reference set, and a first weight sum of the third reference set is obtained through calculation as 30. Tx0 is scheduled according to a magnitude relationship between the weight of Tx0 and the first weight sum. Because the weight of Tx0 is less than the first weight sum, Tx0 is re-executed, so as to retain a blockchain transaction that consumes a relatively large quantity of resources, and re-execute a blockchain transaction that consumes a relatively small quantity of resources, thereby avoiding resource waste and improving performance of the blockchain network.

For three comparison cases between the first weight and the first weight sum, when the first weight is greater than the first weight sum, the target transaction is retained and the first reference transaction is replaced with the target transaction, which is equivalent to temporarily adding the target transaction to the transaction snapshot, and re-executing the first reference transaction; when the first weight is less than the first weight sum, the target transaction is re-executed; and when the first weight equals to the first weight sum, the first reference transaction is replaced with the target transaction, or the first reference transaction is re-executed, so that when the target transaction is scheduled, a blockchain transaction with relatively high resource consumption is retained, and a blockchain transaction with relatively low resource consumption is re-executed, thereby avoiding resource waste and improving performance of the blockchain network.

In one embodiment, the scheduling method for a blockchain transaction further includes:
re-executing the replaced first reference transaction in the transaction snapshot;
using, when the replaced first reference transaction is completely re-executed, the completely re-executed first reference transaction as the target transaction; and
scheduling the target transaction again, until all the blockchain transactions are added to the transaction snapshot.

Transaction scheduling may be performed on the target transaction in a non-deterministic scheduling manner. In non-deterministic scheduling, an execution result of each blockchain transaction is non-deterministic. Non-deterministic scheduling uses specific execution time of the blockchain transaction as a determining standard. Non-deterministic scheduling may be applied to an optimistic scenario. In the optimistic scenario, a conflict transaction is allowed to be replaced. In non-deterministic scheduling, a time point of conflict detection is configured as follows: Each time a blockchain transaction is completely executed, conflict detection is performed on the blockchain transaction, and a conflict relationship between the blockchain transaction and a remaining completely executed blockchain transaction is determined. Therefore, when the blockchain transaction is re-executed, conflict detection needs to be performed on the blockchain transaction again. For example, when the first reference transaction is re-executed, the completely re-executed first reference transaction is used as the target transaction, and a conflict relationship between the target transaction and the remaining completely executed blockchain transaction is determined again. When all blockchain transactions are added to the transaction snapshot, scheduling on the target transaction is completed.

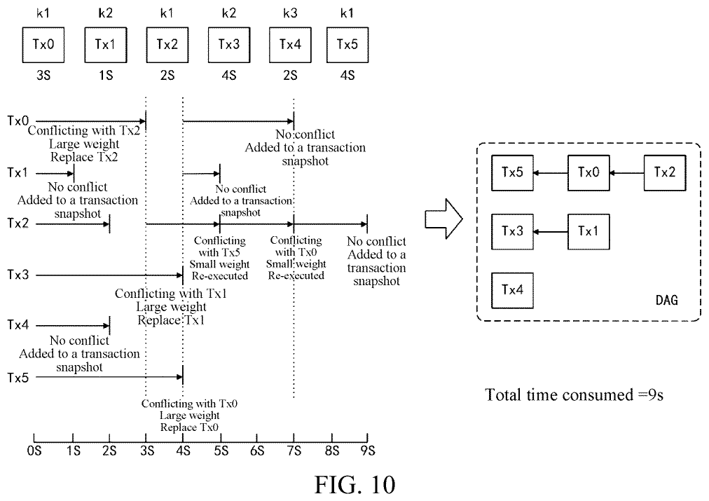

FIG. 10 is another exemplary schematic flowchart after non-deterministic scheduling optimization according to an embodiment of the present disclosure. During non-deterministic scheduling, each time a blockchain transaction is completely executed, conflict detection is performed on the blockchain transaction, to determine a conflict relationship between the blockchain transaction and a remaining completely executed blockchain transaction. In addition, a conflict transaction is allowed to be replaced in an optimistic scenario.

Specifically, six blockchain transactions are executed in parallel, and the six blockchain transactions are respectively: Tx0, Tx1, Tx2, Tx3, Tx4, and Tx5. Execution time of Tx0 is 3 seconds, execution time of Tx1 is 1 second execution time of Tx2 is 2 seconds, execution time of Tx3 is 4 seconds, execution time of Tx4 is 2 seconds, execution time of Tx5 is 4 seconds. Based on resources needing to be consumed for executing each blockchain transaction, it can be determined that a weight of Tx0 is 30, a weight of Tx1 is 10, a weight of Tx2 is 20, a weight of Tx3 is 40, a weight of Tx4 is 20, and a weight of Tx5 is 40.

When 1 second is reached, Tx1 is completely executed, Tx1 is used as the target transaction, it is determined through conflict detection that Tx1 does not conflict with remaining blockchain transactions, and Tx1 is added to the transaction snapshot.

When 2 seconds are reached, Tx2 is completely executed, Tx2 is used as the target transaction, it is determined through conflict detection that Tx2 does not conflict with the remaining blockchain transactions, and Tx2 is added to the transaction snapshot. At the same time, Tx4 is completely executed. Tx4 is used as the target transaction. It is determined through conflict detection that Tx4 does not conflict with the remaining blockchain transactions, and Tx4 is added to the transaction snapshot.

When 3 seconds are reached, Tx0 is completely executed. Tx0 is used as the target transaction. It is determined through conflict detection that Tx2 is the first reference transaction that conflicts with Tx0. Tx0 is scheduled according to a magnitude relationship between the weight of Tx0 and the weight of Tx2. Because the weight of Tx0 is greater than the weight of Tx2, Tx2 in the transaction snapshot is replaced with Tx0, which is equivalent to adding Tx0 to the transaction snapshot, and re-executing Tx2.

When 4 seconds is reached, Tx3 is completely executed, Tx3 is used as the target transaction, it is determined through conflict detection that Tx1 is the first reference transaction that conflicts with Tx3, and Tx3 is scheduled according to a magnitude relationship between the weight of Tx3 and the weight of Tx1. Because the weight of Tx3 is greater than the weight of Tx1, Tx1 in the transaction snapshot is replaced with Tx3, which is equivalent to adding Tx3 to the transaction snapshot, and re-executing Tx1. At the same time, Tx5 is executed completely. Tx5 is used as the target transaction. It is determined through conflict detection that Tx0 is the first reference transaction that conflicts with Tx5. Tx5 is scheduled according to a magnitude relationship between the weight of Tx5 and the weight of Tx0. Because the weight of Tx5 is greater than the weight of Tx0, Tx0 in the transaction snapshot is replaced with Tx5, which is equivalent to adding Tx5 to the transaction snapshot, and re-executing Tx0.

When 5 seconds are reached, Tx1 is completely executed, Tx1 is used as the target transaction, it is determined through conflict detection that Tx1 does not conflict with remaining blockchain transactions, and Tx1 is added to the transaction snapshot. At the same time, Tx2 is completely executed. Tx2 is used as the target transaction. It is determined through conflict detection that Tx5 is the first reference transaction that conflicts with Tx2. Tx2 is scheduled according to a magnitude relationship between the weight of Tx2 and the weight of Tx5. Because the weight of Tx2 is less than the weight of Tx5, Tx2 is re-executed.

When 7 seconds are reached, Tx0 is completely executed, Tx0 is used as the target transaction, it is determined through conflict detection that Tx0 does not conflict with remaining blockchain transactions, and Tx0 is added to the transaction snapshot. At the same time, Tx2 is completely executed. Tx2 is used as the target transaction. It is determined through conflict detection that Tx0 is the first reference transaction that conflicts with Tx2. Tx2 is scheduled according to a magnitude relationship between the weight of Tx2 and the weight of Tx0. Because the weight of Tx2 is less than the weight of Tx0, Tx2 is re-executed.

When 9 seconds are reached, Tx2 is completely executed, Tx2 is used as the target transaction, it is determined through conflict detection that Tx2 does not conflict with the remaining blockchain transactions, and Tx2 is added to the transaction snapshot.

Referring to FIG. 7 again, it can be learned that, compared with total execution time of 12 seconds before non-deterministic scheduling optimization, total execution time after non-deterministic scheduling optimization for the optimistic scenario is 9 seconds, and a reduction of 3 seconds leads to a near 25% improvement in execution efficiency, which is a significant improvement in execution efficiency.

In one embodiment, the resource consumption parameter includes at least one of transaction execution time of the blockchain transaction, a quantity of read set keys of the blockchain transaction, a size of a read set memory of the blockchain transaction, a quantity of write set keys of the blockchain transaction, or a size of a write set memory of the blockchain transaction, and the first weight may be specifically determined by using the following operations:
determining a score value corresponding to at least one of the transaction execution time, the quantity of read set keys, the size of the read set memory, the quantity of the write set keys, and the size of the write set memory of the target transaction; and
obtaining the first weight according to at least one score value.

The resource consumption parameter is configured for indicating a resource required for executing a blockchain transaction. Therefore, the first weight is configured for indicating a resource required for executing the target transaction. The resource required for executing the blockchain transaction may be a time resource, a memory resource, or the like.

For a time resource consumed for executing a blockchain transaction, for a transaction requester, transaction execution time is very sensitive, and may be determined according to transaction execution time of the blockchain transaction. Therefore, the resource consumption parameter may be the transaction execution time.

In addition, for a memory resource consumed for executing a blockchain transaction, for a transaction execution party, information about a related read-write set is an important resource consumption determining factor, and may be determined by using at least one of a quantity of read set keys, a size of a read set memory, a quantity of write set keys, and a size of a write set memory. The reason is as follows:

State data may be stored in a form of a key-value pair. During execution of a blockchain transaction, a read set and a write set are created for the blockchain transaction. The read set is configured for indicating state data read when the blockchain transaction is executed. Therefore, the read set includes a key of the read state data and a committed version number corresponding to the key. The read set may further include a value corresponding to the key. The write set is configured for indicating state data inserted, deleted, or updated when the blockchain transaction is executed. Therefore, the write set includes a key of the written state data and a value corresponding to the key. A quantity of keys of the read set is a quantity of keys included in the read set, and a quantity of keys of the write set is a quantity of keys included in the write set. A memory size of the read set refers to a sum of memories occupied by data in the read set, and a memory size of the write set refers to a sum of memories occupied by data in the write set. It can be learned that creating a read set and a write set both occupy memory space, a larger quantity of keys included in the read set generally occupies more memory resources, and a larger quantity of keys included in the write set generally occupies more memory resources. A larger sum of memories occupied by data in the read set indicates more memory resources consumed, and a larger sum of memories occupied by data in the write set indicates more memory resources consumed.

Therefore, the memory resource consumed for executing the blockchain transaction may be determined by using at least one of the quantity of read set keys, the size of the read set memory, the quantity of the write set keys, and the size of the write set memory. It can be learned that the resource consumption parameter may be the quantity of read set keys, the size of the read set memory, the quantity of the write set keys, and the size of the write set memory.

Another parameter configured for indicating a resource that needs to be consumed for executing a blockchain transaction may be selected as the resource consumption parameter according to an actual situation. This is not limited in this embodiment of the present disclosure.

Specifically, when the first weight is determined by using resource consumption parameters of a plurality of types, for ease of calculation, normalization processing needs to be performed on values of the resource consumption parameters. Therefore, score values corresponding to the resource consumption parameters may be calculated first, and then a sum of the score values is calculated, to obtain the first weight.

In one embodiment, because different resource consumption parameters have different impact degrees on resource consumption determining, a corresponding score value upper limit may be set for each resource consumption parameter.

For example, the score value upper limit s corresponding to the resource consumption parameters are shown in the following Table 1:

TABLE 1

| Score value upper limit | Resource consumption parameter |
|---|---|
| 100 | Transaction execution time |
| 50 | Quantity of read set keys |
| 70 | Size of a read set memory |
| 20 | Quantity of write set keys |
| 30 | Size of a write set memory |

It can be learned from Table 1 that, a corresponding score value upper limit is set according to an impact degree of each resource consumption parameter on resource consumption determining. For example, an impact degree of transaction execution time on resource consumption determining is the maximum. Therefore, a score value upper limit corresponding to the transaction execution time is the maximum. Then, a score value corresponding to the resource consumption parameter may be determined based on the score value upper limit of the resource consumption parameter and an actual parameter value.

Using the transaction execution time as an example, the score value upper limit corresponding to the transaction execution time is 100 scores. A plurality of time thresholds are set, and the 100 scores are divided into a plurality of score intervals. For example, the time threshold may be set to 1 second, 2 seconds, 3 seconds, 4 seconds, and 5 seconds. When the transaction execution time is less than 1 second, the score value corresponding to the transaction execution time is 0 scores, when the transaction execution time is within 1 second to 2 seconds, the score value corresponding to the transaction execution time is within a score interval from 0 scores to 20 scores, when the transaction execution time is within 2 seconds to 3 seconds, the score value corresponding to the transaction execution time is within a score interval from 20 scores to 50 scores, and when the transaction execution time is within 3 seconds to 4 seconds, the score value corresponding to the transaction execution time is within a score interval from 50 scores to 80 scores, when the transaction execution time is within 4 seconds to 5 seconds, the score value corresponding to the transaction execution time is within a score interval from 80 scores to 100 scores. When the transaction execution time is greater than 5 seconds, the score value corresponding to the transaction execution time is 100. Within the score interval, an actual score value may be determined according to a linear relationship between the score value and the transaction execution time. Similarly, a score value corresponding to another resource consumption parameter may be calculated, and then all score values are added to obtain the first weight.

According to an actual situation, the score value upper limit corresponding to the resource consumption parameter may be set to another value. This is not limited in this embodiment of the present disclosure.

In another embodiment, the same score value upper limit may be set for each resource consumption parameter. For example, the score value upper limit is set to 100 scores. Using the transaction execution time as an example again, the score value corresponding to the transaction execution time is determined according to the foregoing score value determining method, and score values corresponding to other resource consumption parameters are determined according to a score value determining method based on the same principle. Because different resource consumption parameters have different impact degrees on resource consumption determining, corresponding weight values may be set for score values corresponding to different resource consumption parameters according to impact degrees of the resource consumption parameters on resource consumption determining. Then, based on the corresponding weight values, weighting processing is performed on the score values corresponding to the resource consumption parameters, and then all weighted score values are added to obtain the first weight.

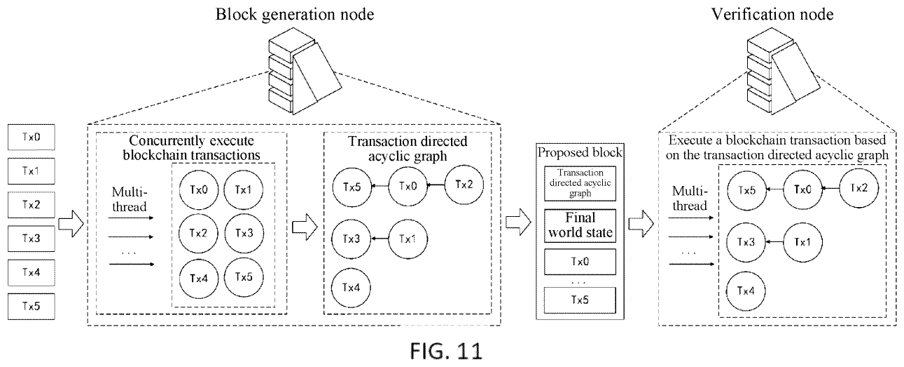

FIG. 11 is an exemplary schematic flowchart of block verification between nodes according to an embodiment of the present disclosure. A blockchain network includes a block generation node and a verification node. There may be a plurality of verification nodes. A plurality of blockchain transactions such as Tx0, Tx1, Tx2, Tx3, Tx4, and Tx5 are executed in parallel by using the block generation node via a plurality of threads. A completely executed blockchain transaction is used as a target transaction. When the target transaction and a first reference transaction that conflict with each other are scheduled, a first weight of the target transaction and a second weight of the first reference transaction are first obtained. Both the first weight and the second weight are determined based on a resource consumption parameter. Scheduling the target transaction according to a magnitude relationship between the first weight and the second weight is equivalent to scheduling the target transaction according to the resource consumption parameter, so that when the target transaction is scheduled, a blockchain transaction that consumes a relatively large quantity of resources is retained, and a blockchain transaction that consumes a relatively small quantity of resources is re-executed, thereby avoiding resource waste and improving performance of a blockchain network. A transaction directed acyclic graph is constructed according to a scheduling result of the target transaction, and the transaction directed acyclic graph and each blockchain transaction are packaged, to obtain a proposed block carrying the directed acyclic graph, the proposed block further includes a final world state determined according to an execution result of the blockchain transaction. The block generation node transmits the proposed block to each verification node. The verification node can execute a blockchain transaction in the proposed block based on the transaction directed acyclic graph, to obtain a reference world state, and compare the reference state with the final state. When the reference world state is the same as the final world state, it is determined that verification of the proposed block succeeds; otherwise, the verification fails.

Although the operations in the flowcharts are displayed sequentially according to the instructions of the arrows, these operations are not necessarily performed sequentially according to the sequence instructed by the arrows. Unless otherwise explicitly specified in the embodiments, execution of the operations is not strictly limited, and the operations may be performed in other sequences. Moreover, at least some of the operations in the flowcharts may include a plurality of operations or a plurality of stages. The operations or stages are not necessarily performed at the same time but may be performed at different time. Execution of the operations or stages is not necessarily sequentially performed, but may be performed in turn or alternately with other operations or at least some of operations or stages of other operations.

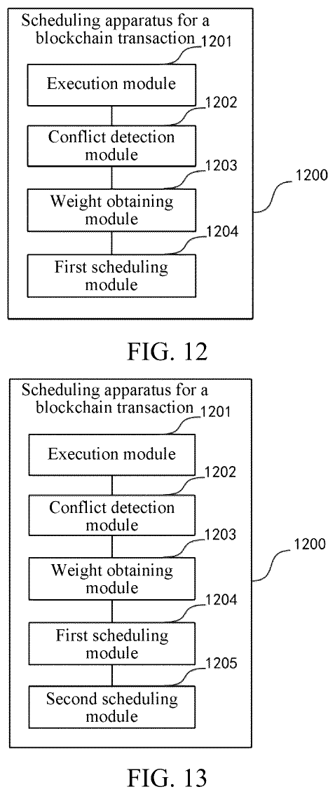

FIG. 12 is an exemplary schematic structural diagram of a scheduling apparatus for a blockchain transaction according to an embodiment of the present disclosure. The scheduling apparatus 1200 for a blockchain transaction includes:
an execution module 1201, configured to: obtain a plurality of to-be-executed blockchain transactions, and execute the blockchain transactions;
a conflict detection module 1202, configured to: obtain a completely executed target transaction from the blockchain transactions, and determine a first conflict relationship between the target transaction and at least one first reference transaction, the first reference transaction being a currently completely executed blockchain transaction other than the target transaction;
a weight obtaining module 1203, configured to: obtain a first weight of the target transaction and a second weight of the first reference transaction when the first conflict relationship indicates that a conflict exists between the target transaction and the first reference transaction, the first weight being determined based on a resource consumption parameter during execution of the target transaction, and the second weight being determined based on a resource consumption parameter during execution of the first reference transaction; and
a first scheduling module 1204, configured to schedule the target transaction according to a magnitude relationship between the first weight and the second weight.

Further, the first scheduling module 1204 is specifically configured to:
schedule the target transaction according to a magnitude relationship between the first weight and each second weight; or
calculate a sum of second weights as a first weight sum, and schedule the target transaction according to a magnitude relationship between the first weight and the first weight sum.

Further, the target transaction is obtained after all the blockchain transactions are completely executed, the first reference transaction is not added to the transaction snapshot, and the first scheduling module 1204 is specifically configured to:
add the target transaction to the transaction snapshot when the first weight is greater than each second weight; or
re-execute the target transaction when the first weight is less than any second weight; or
add the target transaction to the transaction snapshot or re-execute the target transaction when the first weight equals to a maximum value in the second weights.

Further, the first scheduling module 1204 is specifically configured to:
form a first transaction set by using the target transaction and a first reference transaction corresponding to a second weight equal to the first weight; and
add any blockchain transaction in the first transaction set to the transaction snapshot, and re-execute a remaining blockchain transaction in the first transaction set.

FIG. 12 is another exemplary schematic structural diagram of a scheduling apparatus for a blockchain transaction according to an embodiment of the present disclosure. The scheduling apparatus 1200 for a blockchain transaction further includes:
a second scheduling module 1205, configured to: use, when blockchain transactions not added to the transaction snapshot are completely re-executed, a blockchain transaction that is completely re-executed and that is not added to the transaction snapshot as the target transaction; and schedule the target transaction again, until all the blockchain transactions are added to the transaction snapshot.

Further, the target transaction is obtained each time a blockchain transaction is completely executed, the first reference transaction is not added to the transaction snapshot, and the first scheduling module 1204 is specifically configured to:
wait for preset duration when the first weight is greater than the first weight sum, and schedule the target transaction after waiting duration reaches the preset duration; or
re-execute the target transaction when the first weight is less than the first weight sum; or
wait for preset duration when the first weight equals to the first weight sum, and schedule the target transaction or re-execute the target transaction after waiting duration reaches the preset duration.

Further, the conflict detection module 1202 is specifically configured to:
determine a second conflict relationship between the target transaction and a second reference transaction, the second reference transaction being a blockchain transaction that is other than the target transaction, that is currently completely executed, and that has been added to the transaction snapshot; and
determine the first conflict relationship between the target transaction and the at least one first reference transaction when the second conflict relationship indicates that no conflict exists between the target transaction and the second reference transaction.

Further, the first scheduling module 1204 is specifically configured to:
determine a third conflict relationship between the target transaction and at least one third reference transaction after the waiting duration reaches the preset duration, the third reference transaction being a blockchain transaction that is other than the target transaction, that is currently completely executed, and that is not added to the transaction snapshot;
obtain a third weight of the third reference transaction when the third conflict relationship indicates that a conflict exists between the target transaction and the third reference transaction, the third weight being determined based on a resource consumption parameter during execution of the third reference transaction; and
calculate a sum of third weights as a second weight sum, and schedule the target transaction according to a magnitude relationship between the first weight and the second weight sum.

Further, the first scheduling module 1204 is specifically configured to:
add the target transaction to the transaction snapshot when the first weight is greater than the second weight sum; or
re-execute the target transaction when the first weight is less than the second weight sum; or
add the target transaction to the transaction snapshot or re-execute the target transaction when the first weight equals to the second weight sum.

Further, the first scheduling module 1204 is specifically configured to:
determine a fourth conflict relationship between the target transaction and a fourth reference transaction, the fourth reference transaction being a blockchain transaction that is other than the target transaction, that is currently completely executed, and that has been added to the transaction snapshot; and
determine the third conflict relationship between the target transaction and the at least one third reference transaction when the fourth conflict relationship indicates that no conflict exists between the target transaction and the fourth reference transaction.

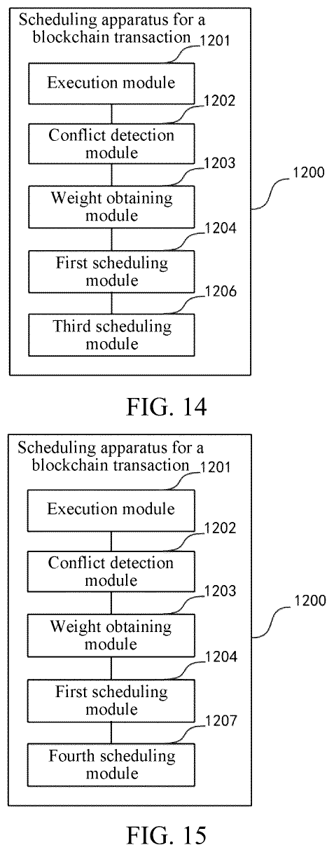

FIG. 14 is another exemplary schematic structural diagram of a scheduling apparatus for a blockchain transaction according to an embodiment of the present disclosure. The scheduling apparatus 1200 for a blockchain transaction further includes:
a third scheduling module 1206, configured to: use, when blockchain transactions not added to the transaction snapshot are completely re-executed, a blockchain transaction that is completely re-executed and that is not added to the transaction snapshot as the target transaction; and schedule the target transaction again, until all the blockchain transactions are added to the transaction snapshot.

Further, the target transaction is obtained each time a blockchain transaction is completely executed, the first reference transaction has been added to the transaction snapshot, and the first scheduling module 1204 is specifically configured to:
replacing the first reference transaction in the transaction snapshot with the target transaction when the first weight is greater than the first weight sum; or
re-executing the target transaction when the first weight is less than the first weight sum; or
replacing the first reference transaction in the transaction snapshot with the target transaction or re-executing the target transaction when the first weight equals to the first weight sum.

FIG. 15 is another exemplary schematic structural diagram of a scheduling apparatus for a blockchain transaction according to an embodiment of the present disclosure. The scheduling apparatus 1200 for a blockchain transaction further includes:
a fourth scheduling module 1207, configured to re-execute the replaced first reference transaction in the transaction snapshot; use, when the replaced first reference transaction is completely re-executed, the completely re-executed first reference transaction as the target transaction; and schedule the target transaction again, until all the blockchain transactions are added to the transaction snapshot.

Further, the resource consumption parameter includes at least one of transaction execution time of the blockchain transaction, a quantity of read set keys of the blockchain transaction, a size of a read set memory of the blockchain transaction, a quantity of write set keys of the blockchain transaction, or a size of a write set memory of the blockchain transaction, and the weight obtaining module 1203 is specifically configured to:
determine a score value corresponding to at least one of the transaction execution time, the quantity of read set keys, the size of the read set memory, the quantity of the write set keys, and the size of the write set memory of the target transaction; and
obtain the first weight according to at least one score value.

The foregoing scheduling apparatus 1200 for a blockchain transaction and the scheduling method for a blockchain transaction are based on the same inventive concept. A plurality of blockchain transactions are executed, a completely executed blockchain transaction is used as a target transaction, and when the target transaction and a first reference transaction that conflict with each other are scheduled, a first weight of the target transaction and a second weight of the first reference transaction are obtained. The first weight and the second weight are both determined based on a resource consumption parameter. Therefore, scheduling the target transaction according to a magnitude relationship between the first weight and the second weight is equivalent to scheduling the target transaction according to the resource consumption parameter. Therefore, when the target transaction is scheduled, a blockchain transaction consuming a relatively large quantity of resources can be retained and a blockchain transaction consuming a relatively small quantity of resources can be re-executed, to avoid resource waste and improve performance of a blockchain network.

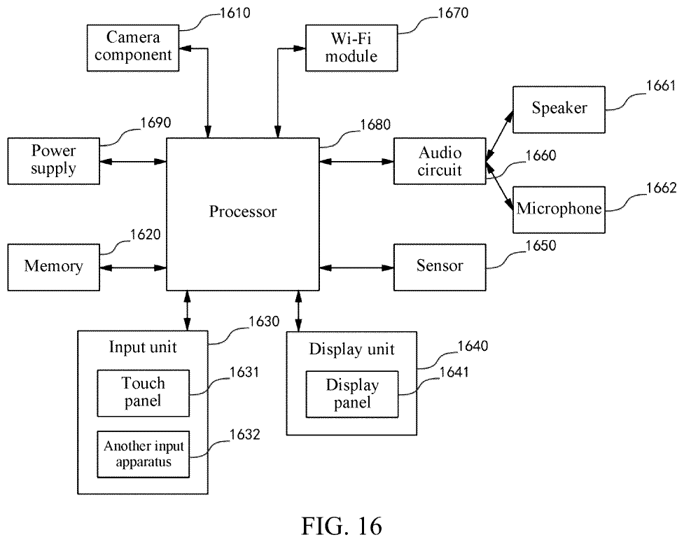

An electronic device that is configured to perform the foregoing scheduling method for a blockchain transaction and that is provided in an embodiment of the present disclosure may be a terminal. FIG. 16 is a partial structural block diagram of a terminal according to an embodiment of the present disclosure. The terminal includes: components such as a camera component 1610, a memory 1620, an input unit 1630, a display unit 1640, a sensor 1650, an audio circuit 1660, a wireless fidelity (Wi-Fi) module 1670, a processor 1680, and a power supply 1690. A person skilled in the art may understand that the terminal structure shown in FIG. 16 does not constitute a limitation on the terminal, and the terminal may include more or fewer components than those shown, or combine some components, or have different component arrangements.

The camera component 1610 may be configured to capture an image or a video. In some embodiments, the camera component 1610 includes a front camera and a rear camera. Generally, the front-facing camera is disposed on the front panel of the terminal, and the rear-facing camera is disposed on a back surface of the terminal. In some embodiments, there are at least two rear cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions.

The memory 1620 may be configured to store a software program and a module, and the processor 1680 runs the software program and the module stored in the memory 1620, to perform various functional applications and data processing of the terminal.

The input unit 1630 may be configured to receive inputted digit or character information, and generate a key signal input related to settings and function control of the terminal. Specifically, the input unit 1630 may include a touch panel 1631 and another input apparatus 1632.

The display unit 1640 may be configured to display input information or provided information and various menus of the terminal. The display unit 1640 may include a display panel 1641.

The audio circuit 1660, the speaker 1661, and the microphone 1662 may provide an audio interface.

The power supply 1690 may be an alternating-current power supply, a direct-current power supply, a disposable battery, or a rechargeable battery.

There may be one or more sensors 1650, and the one or more sensors 1650 include but are not limited to: an acceleration sensor, a gyro sensor, a pressure sensor, an optical sensor, and the like.

The acceleration sensor may detect a magnitude of acceleration on three coordinate axes of a coordinate system established with the terminal. For example, the acceleration sensor may be configured to detect components of gravity acceleration on the three coordinate axes. The processor 1680 may control, based on a gravity acceleration signal collected by the acceleration sensor, the display unit 1640 to display the user interface in a landscape view or a portrait view. The acceleration sensor may be further configured to acquire motion data of a game or a user.

The gyroscope sensor may detect a body direction and a rotation angle of the terminal, and the gyroscope sensor may work with the acceleration sensor to collect a 3D action performed by the user on the terminal. The processor 1680 may implement the following functions according to the data collected by the gyroscope sensor: motion sensing (such as changing the UI according to a tilt operation of the user), image stabilization at shooting, game control, and inertial navigation.

The pressure sensor may be disposed at a side frame of the terminal and/or a lower layer of the display unit 1640. When the pressure sensor is disposed at the side frame of the terminal, a holding signal of the user on the terminal may be detected. The processor 1680 performs left/right hand recognition or a quick operation according to the holding signal acquired by the pressure sensor. When the pressure sensor is disposed on the low layer of the display unit 1640, the processor 1680 controls an operable control on the UI based on a pressure operation by the user for the display unit 1640. The operable control includes at least one of a button control, a scroll-bar control, an icon control, and a menu control.

The optical sensor is configured to collect ambient light intensity. In an embodiment, the processor 1680 may control display luminance of the display unit 1640 according to the ambient light intensity collected by the optical sensor. Specifically, when the ambient light intensity is relatively high, the display brightness of the display unit 1640 is increased. When the ambient light intensity is relatively low, the display brightness of the display unit 1640 is reduced. In another embodiment, the processor 1680 may further dynamically adjust a camera parameter of the camera assembly 1610 according to the ambient light intensity acquired by the optical sensor.

In this embodiment, the processor 1680 included in the terminal may perform the scheduling method for a blockchain transaction in the foregoing embodiment.

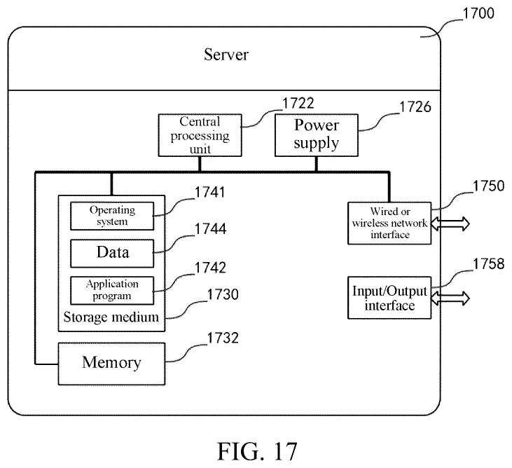

An electronic device configured to perform the foregoing scheduling method for a blockchain transaction provided in the embodiment of the present disclosure may alternatively be a server. FIG. 17 is a partial structural block diagram of a server according to an embodiment of the present disclosure. A server 1700 may generate relatively large differences due to different configurations or different performance. The server 1700 may include one or more central processing units (CPU) 1722, for example, one or more processors, a memory 1732, and one or more storage media 1730 (for example, one or more mass storage apparatuses) for storing an application program 1742 or data 1744. The memory 1732 and the storage medium 1730 may be configured for transient storage or persistent storage. A program stored in the storage medium 1730 may include one or more modules (not marked in the figure), and each module may include a series of instruction operations on the server 1700. Still further, the central processing unit 1722 may be configured to communicate with the storage medium 1730, and perform, on the server 1700, the series of instruction operations in the storage medium 1730.

The server 1700 may further include one or more power supplies 1726, one or more wired or wireless network interfaces 1750, one or more input/output interfaces 1758, and/or one or more operating systems 1741, such as Windows Server™, Mac OS X™, Unix™, Linux™, and FreeBSD™.

The processor in the server 1700 may be configured to perform the scheduling method for a blockchain transaction.

An embodiment of the present disclosure further provides a computer-readable storage medium. The computer-readable storage medium is configured to store program code. The program code is configured for performing the scheduling method for a blockchain transaction according to the foregoing embodiments.

An embodiment of the present disclosure further provides a computer program product, where the computer program product includes a computer program, and the computer program is stored in a computer-readable storage medium. A processor of an electronic device reads the computer program from the computer-readable storage medium, and the processor executes the computer program to cause the electronic device to implement the foregoing scheduling method for a blockchain transaction.

Embodiments of the present disclosure at least have the following beneficial effects. A plurality of blockchain transactions are executed, a completely executed blockchain transaction is used as a target transaction, and when the target transaction and a first reference transaction that conflict with each other are scheduled, a first weight of the target transaction and a second weight of the first reference transaction are obtained. The first weight and the second weight are both determined based on a resource consumption parameter. Therefore, scheduling the target transaction according to a magnitude relationship between the first weight and the second weight is equivalent to scheduling the target transaction according to the resource consumption parameter. Therefore, when the target transaction is scheduled, a blockchain transaction consuming a relatively large quantity of resources can be retained and a blockchain transaction consuming a relatively small quantity of resources can be re-executed, to avoid resource waste and improve performance of a blockchain network.

The terms such as “first”, “second”, “third”, and “fourth” (if exist) in the specification of the present disclosure and in the accompanying drawings are configured for distinguishing between similar objects and not necessarily configured for describing any particular order or sequence. Data used in this way is exchangeable in a proper case, so that the embodiments of the present disclosure described herein can be implemented in an order different from the order shown or described herein. Moreover, the terms “include”, “contain” and any other variants mean to cover the non-exclusive inclusion. For example, a process, method, system, product, or apparatus that includes a list of operations or units is not necessarily limited to those operations or units, but may include other operations or units not expressly listed or inherent to such a process, method, product, or apparatus.

In the present disclosure, “at least one” means one or more, and “a plurality of” means two or more. The term “and/or” is configured for describing an association relationship between associated objects and representing that three relationships may exist. For example, “A and/or B” may represent the following three cases: Only A exists, both A and B exist, and only B exists, where A and B may be singular or plural. The character “/” in this specification generally indicates an “or” relationship between the associated objects. “At least one item (piece) of the following” or a similar expression means any combination of these items, including a single item (piece) or any combination of a plurality of items (pieces). For example, at least one of a, b, or c may represent: a, b, c, a and b, a and c, b and c, or a, b, and c, where a, b, and c may be singular or plural.

In the descriptions of the embodiments of the present disclosure, a plurality of (or multiple) means two or more, being greater than, being less than, and exceed a number, and the like are understood as excluding the number, and above, below, and within a number, and the like are understood as including the number.

In the several embodiments provided in the present disclosure, the disclosed system, apparatus, and method may be implemented in other manners. For example, the described apparatus embodiment is merely an example. For example, the unit division is merely a logical function division and may be other division during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, functional units in the embodiments of the present disclosure may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the related art, or all or some of the technical solutions may be implemented in the form of a software product. The computer software product is stored in a storage medium and includes several instructions for instructing a computer apparatus (which may be a personal computer, a server, a network apparatus, or the like) to perform all or some of the operations of the methods described in the embodiments of the present disclosure. The foregoing storage medium includes: various media capable of storing program code, such as a USB flash drive, a mobile hard disk, a read-only memory (ROM), a random access memory (RAM), a magnetic disk, or an optical disc.

Various implementations provided in the embodiments of the present disclosure may be combined in different manners to form other embodiments, to achieve different technical effects.

The foregoing describes the exemplary implementations of the present disclosure in detail, but the present disclosure is not limited to the foregoing implementations. A person skilled in the art may further make various equivalent variants or replacements without departing from the spirit of the present disclosure, and these equivalent variants or replacements are all included within the scope defined by the claims of the present disclosure.

What is claimed is:

1. A scheduling method for a blockchain transaction, performed by an electronic device and comprising:
obtaining a plurality of blockchain transactions for execution, and executing the plurality of blockchain transactions;
obtaining a target transaction, that is completely executed, from the blockchain transactions, and determining a first conflict relationship between the target transaction and a first reference transaction of at least one first reference transaction, the first reference transaction being a currently, completely executed blockchain transaction other than the target transaction;
obtaining a first weight of the target transaction and a second weight of the first reference transaction when the first conflict relationship indicates that a conflict exists between the target transaction and the first reference transaction, the first weight being determined based on a resource consumption parameter during execution of the target transaction, and the second weight being determined based on a resource consumption parameter during execution of the first reference transaction; and
scheduling the target transaction according to a magnitude relationship between the first weight and the second weight.

2. The scheduling method according to claim 1, wherein scheduling the target transaction according to the magnitude relationship between the first weight and the second weight comprises:
scheduling the target transaction according to a magnitude relationship between the first weight and another second weight of the at least one first reference transaction; or
calculating a sum of second weights of the at least one first reference transaction as a first weight sum, and scheduling the target transaction according to a magnitude relationship between the first weight and the first weight sum.

3. The scheduling method according to claim 2, wherein the target transaction is obtained after all blockchain transactions are completely executed, the first reference transaction is not added to a transaction snapshot, and scheduling the target transaction according to the magnitude relationship between the first weight and another second weight comprises:
adding the target transaction to the transaction snapshot when the first weight is greater than the second weight of the at least one first reference transaction; or
re-executing the target transaction when the first weight is less than any second weight; or
adding the target transaction to the transaction snapshot or re-executing the target transaction when the first weight equals to a maximum value in the second weights of the at least one first reference transaction.

4. The scheduling method according to claim 3, wherein adding the target transaction to the transaction snapshot or re-executing the target transaction comprises:
forming a first transaction set by using the target transaction and one first reference transaction corresponding to one second weight equal to the first weight; and
adding any blockchain transaction in the first transaction set to the transaction snapshot, and re-executing a remaining blockchain transaction in the first transaction set.

5. The scheduling method according to claim 3, further comprising:
using, when all blockchain transactions not added to the transaction snapshot are completely re-executed, a blockchain transaction that is completely re-executed and that is not added to the transaction snapshot as the target transaction; and
scheduling the target transaction, until all the blockchain transactions are added to the transaction snapshot.

6. The scheduling method according to claim 2, wherein the target transaction is obtained when one blockchain transaction is completely executed, the first reference transaction is not added to the transaction snapshot, and scheduling the target transaction according to the magnitude relationship between the first weight and the first weight sum comprises:
waiting for a preset duration when the first weight is greater than the first weight sum, and scheduling the target transaction after the waiting duration reaches the preset duration; or
re-executing the target transaction when the first weight is less than the first weight sum; or
waiting for a preset duration when the first weight equals to the first weight sum, and scheduling the target transaction or re-executing the target transaction after the waiting duration reaches the preset duration.

7. The scheduling method according to claim 6, wherein determining the first conflict relationship between the target transaction and the first reference transaction of the at least one first reference transaction comprises:
determining a second conflict relationship between the target transaction and a second reference transaction, the second reference transaction being a blockchain transaction that is other than the target transaction, that is currently completely executed, and that has been added to the transaction snapshot; and
determining the first conflict relationship between the target transaction and the first reference transaction of the at least one first reference transaction when the second conflict relationship indicates that no conflict exists between the target transaction and the second reference transaction.

8. The scheduling method according to claim 6, wherein scheduling the target transaction after the waiting duration reaches the preset duration comprises:
determining a third conflict relationship between the target transaction and a third reference transaction of at least one third reference transaction after the waiting duration reaches the preset duration, the third reference transaction being a blockchain transaction that is other than the target transaction, that is currently completely executed, and that is not added to the transaction snapshot;
obtaining a third weight of the third reference transaction of the at least one third reference transaction when the third conflict relationship indicates that a conflict exists between the target transaction and the third reference transaction, the third weight being determined based on a resource consumption parameter during execution of the third reference transaction; and
calculating a sum of third weights of the at least one third reference transaction as a second weight sum, and scheduling the target transaction according to a magnitude relationship between the first weight and the second weight sum.

9. The scheduling method according to claim 8, wherein scheduling the target transaction according to the magnitude relationship between the first weight and the second weight sum comprises:
adding the target transaction to the transaction snapshot when the first weight is greater than the second weight sum; or
re-executing the target transaction when the first weight is less than the second weight sum; or
adding the target transaction to the transaction snapshot or re-executing the target transaction when the first weight equals to the second weight sum.

10. The scheduling method according to claim 8, wherein determining the third conflict relationship between the target transaction and the third reference transaction of the at least one third reference transaction comprises:
determining a fourth conflict relationship between the target transaction and a fourth reference transaction, the fourth reference transaction being a blockchain transaction that is other than the target transaction, that is currently completely executed, and that has been added to the transaction snapshot; and
determining the third conflict relationship between the target transaction and the at least one third reference transaction when the fourth conflict relationship indicates that no conflict exists between the target transaction and the fourth reference transaction.

11. The scheduling method according to claim 6, further comprising:
using, when blockchain transactions not added to the transaction snapshot are completely re-executed, a blockchain transaction that is completely re-executed and that is not added to the transaction snapshot as the target transaction; and
scheduling the target transaction, until all the blockchain transactions are added to the transaction snapshot.

12. The scheduling method according to claim 2, wherein the target transaction is obtained when one blockchain transaction is completely executed, the first reference transaction has been added to the transaction snapshot, and scheduling the target transaction according to the magnitude relationship between the first weight and the first weight sum comprises:
replacing the first reference transaction in the transaction snapshot with the target transaction when the first weight is greater than the first weight sum; or
re-executing the target transaction when the first weight is less than the first weight sum; or
replacing the first reference transaction in the transaction snapshot with the target transaction or re-executing the target transaction when the first weight equals to the first weight sum.

13. The scheduling method according to claim 12, further comprising:
re-executing the replaced first reference transaction in the transaction snapshot;
using, when the replaced first reference transaction is completely re-executed, the completely re-executed first reference transaction as the target transaction; and
scheduling the target transaction, until all the blockchain transactions are added to the transaction snapshot.

14. The scheduling method according to claim 1, wherein the resource consumption parameter comprises at least one of transaction execution time of the blockchain transaction, a quantity of read set keys of the blockchain transaction, a size of a read set memory of the blockchain transaction, a quantity of write set keys of the blockchain transaction, or a size of a write set memory of the blockchain transaction, and the first weight is determined by using following operations:
determining a score value corresponding to at least one of the transaction execution time, the quantity of read set keys, the size of the read set memory, the quantity of the write set keys, or the size of the write set memory of the target transaction; and
obtaining the first weight according to at least one score value.

15. An electronic device, comprising one or more processors and a memory containing a computer program that, when being executed, causes the one or more processors to perform:
obtaining a plurality of blockchain transactions for execution, and executing the plurality of blockchain transactions;
obtaining a target transaction, that is completely executed, from the blockchain transactions, and determining a first conflict relationship between the target transaction and a first reference transaction of at least one first reference transaction, the first reference transaction being a currently, completely executed blockchain transaction other than the target transaction;
obtaining a first weight of the target transaction and a second weight of the first reference transaction when the first conflict relationship indicates that a conflict exists between the target transaction and the first reference transaction, the first weight being determined based on a resource consumption parameter during execution of the target transaction, and the second weight being determined based on a resource consumption parameter during execution of the first reference transaction; and
scheduling the target transaction according to a magnitude relationship between the first weight and the second weight.

16. The device method according to claim 15, wherein the one or more processors are further configured to perform:
scheduling the target transaction according to a magnitude relationship between the first weight and another second weight of the at least one first reference transaction; or
calculating a sum of second weights of the at least one first reference transaction as a first weight sum, and scheduling the target transaction according to a magnitude relationship between the first weight and the first weight sum.

17. The device according to claim 16, wherein the target transaction is obtained after all blockchain transactions are completely executed, the first reference transaction is not added to a transaction snapshot, and the one or more processors are further configured to perform:
adding the target transaction to the transaction snapshot when the first weight is greater than the second weight of the at least one first reference transaction; or
re-executing the target transaction when the first weight is less than any second weight; or
adding the target transaction to the transaction snapshot or re-executing the target transaction when the first weight equals to a maximum value in the second weights of the at least one first reference transaction.

18. The device according to claim 17, wherein the one or more processors are further configured to perform:
forming a first transaction set by using the target transaction and one first reference transaction corresponding to one second weight equal to the first weight; and
adding any blockchain transaction in the first transaction set to the transaction snapshot, and re-executing a remaining blockchain transaction in the first transaction set.

19. The device according to claim 17, wherein the one or more processors are further configured to perform:
using, when all blockchain transactions not added to the transaction snapshot are completely re-executed, a blockchain transaction that is completely re-executed and that is not added to the transaction snapshot as the target transaction; and
scheduling the target transaction, until all the blockchain transactions are added to the transaction snapshot.

20. A non-transitory computer-readable storage medium containing a computer program that, when being executed, causes at least one processor to perform:
obtaining a plurality of blockchain transactions for execution, and executing the plurality of blockchain transactions;
obtaining a target transaction, that is completely executed, from the blockchain transactions, and determining a first conflict relationship between the target transaction and a first reference transaction of at least one first reference transaction, the first reference transaction being a currently, completely executed blockchain transaction other than the target transaction;
obtaining a first weight of the target transaction and a second weight of the first reference transaction when the first conflict relationship indicates that a conflict exists between the target transaction and the first reference transaction, the first weight being determined based on a resource consumption parameter during execution of the target transaction, and the second weight being determined based on a resource consumption parameter during execution of the first reference transaction; and
scheduling the target transaction according to a magnitude relationship between the first weight and the second weight.
